(19) United States
(12) Patent Application Publication
(10) Pub. No.: US 2013/0066093 A1
(43) Pub. Date: Mar. 14, 2013

(54) METAL (II) COORDINATION POLYMERS AND SYNTHESIZING METHOD THEREOF

(71) Applicants: Chia-Her LIN, Tao-Yuan (TW); Chun-Ting YEH, Taipei City (TW)

(72) Inventors: Chia-Her LIN, Tao-Yuan (TW); Chun-Ting YEH, Taipei City (TW)

(73) Assignee: CHUNG YUAN CHRISTIAN UNIVERSITY, Tao-Yuan (TW)

(21) Appl. No.: 13/298,167

(22) Filed: Nov. 16, 2011

(30) Foreign Application Priority Data
Sep. 9, 2011 (TW) 100132558

(51) Int. Cl. C07F 13/00; C07F 3/00; C07F 3/04; C07F 3/02; C07F 3/06

(52) U.S. Cl. 556/45; 562/429; 556/120

(57) ABSTRACT

The present invention relates to metal (II) coordination polymers and synthesizing method therefore, and particularly relates to metal (II) coordination polymers, in which divalent metal ions are Mg, Ca, Sr, Mn, or Zn and organic ligands are 4,4′-sulfonyldibenzoic acids (H₂SBA), and synthesizing method therefore.

### CROSS-REFERENCE TO RELATED APPLICATIONS

The entire contents of Taiwan Patent Application No. 100132558, filed on Sep. 9, 2011, from which this application claims priority, are incorporated herein by reference.

### BACKGROUND OF THE INVENTION

1. Field of the Invention

The present invention relates to metal (II) coordination polymers and synthesizing method therefore, and particularly relates to metal (II) coordination polymers, in which metal ions are Mg, Ca, Sr, Mn, or Zn and organic ligands are 4,4′-sulfonyldibenzoic acids (H₂SBA), and synthesizing method therefore.

2. Description of Related Art

Organic-inorganic metal coordination polymer is also called metal-organic framework (MOF). It is a porous material composed of inorganic metal ions and organic ligands. Inorganic metal ions and organic ligands are self-assembled in a solvent by covalent bonding and other weaker chemical bonding, for example hydrogen bond and π-π stacking, to form 1D, 2D, and 3D metal-organic frameworks through different stacking methods.

Comparing with other porous materials, the porous materials composed of inorganic metal ions and organic ligands have many advantages, for example simple synthesizing process, low cost, adjustable pore size and characteristic, pre-designed ligands, etc. Therefore, the porous material composed of an organic-inorganic metal coordination polymer is commonly applied in various kinds of industry fields and science fields, for example it is applied to gas absorption, gas storage, catalytic and magnetism. In all applications in which the organic-inorganic metal coordination polymers is applied to gas absorption, applications for absorption of hydrogen gas and carbon dioxide gas are more valuable. The organic-inorganic metal coordination polymers have the advantage of well hydrogen gas absorption/desorption. Therefore, they can be utilized to store hydrogen gas instead of the traditional method in which the hydrogen gas is liquefied at high temperature and pressure and stored in a heavy steel cylinder. Furthermore, the organic-inorganic metal coordination polymers also have the advantage of well carbon dioxide gas absorption/desorption. Therefore, they can be utilized in green chemistry to efficiently absorb carbon dioxide for avoiding pollution and influence on environment.

Mostly, transition metals are used to be the metal center of metal-organic frameworks (MOFs) because transition metals have d orbitals to get higher coordination number and magnetic application. However, comparing with transition metals, these environmentally friendly, non-toxic and cheap alkaline-earth metals are rarely utilized to synthesize metal-organic frameworks (MOFs) because alkaline-earth metals lack d orbitals. Therefore, it is not easy to synthesize porous metal-organic frameworks (MOFs) by alkaline-earth metals. However, in trend of environment protection and green chemistry, comparing with use of toxic and expansive transition metals, use of environmentally friendly, non-toxic and cheap alkaline-earth metals is a better choice for synthesizing metal-organic frameworks (MOFs). But, it is necessary to overcome the disadvantage that it is not easy to synthesize porous and 3D metal-organic frameworks (MOFs).

Therefore, it has a need to an organic-inorganic metal coordination polymer in which an alkaline-earth metal ion is a metal center and synthesizing method thereof.

### SUMMARY OF THE INVENTION

In view of the foregoing, one object of the present invention is to provide a novel organic-inorganic metal coordination polymer and synthesizing method thereof, in which the environmentally friendly, non-toxic and cheap alkaline-earth metal ion, for example magnesium (Mg), Calcium (Ca), or Strontium (Sr), is a metal center and 4,4′-sulfonyldibenzoic acids (H₂SBA) are organic ligands. This novel organic-inorganic metal coordination polymer has good absorption/desorption for hydrogen gas and carbon dioxide gas.

Another object of the present invention is to provide a novel organic-inorganic metal coordination polymer and synthesizing method thereof, in which transition metal ion Manganese (Mn) or Zinc (Zn) is a metal center and 4,4′-sulfonyldibenzoic acids (H₂SBA) are organic ligands.

According to the objects above, a novel organic-inorganic metal (II) coordination polymer having good absorption/desorption for hydrogen gas and carbon dioxide gas is disclosed herein. In the organic-inorganic metal (II) coordination polymer, an alkaline-earth metal ion, for example magnesium (Mg), Calcium (Ca), or Strontium (Sr), is a metal center and 4,4′-sulfonyldibenzoic acids (H₂SBA) are organic ligands. Each unit of the organic-inorganic metal (II) coordination polymer comprises one or several metal (II) used to be central metal ions and a plurality of 4,4′-sulfonyldibenzoic acids (H₂SBA) used to be organic ligands.

According to the objects above, a method for synthesizing a novel organic-inorganic metal (II) coordination polymer is disclosed herein. This method utilizes hydrothermal method or microwave syntheses method. This method comprises the following steps: putting metal nitrate, 4,4′-sulfonyldibenzoic acids (H₂SBA), organic solvent, and water into a reactor in order; heating the reactor to a predetermined temperature; reacting at the predetermined temperature for a predetermined time; cooling the reactor to room temperature; and suction filtration, washing with ethanol and water, and drying to get a metal (II) coordination polymer.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1A and FIG. 1B show the structure of the asymmetric unit of compound 1.

FIG. 1C shows the coordination environment of one 4,4′-sulfonyldibenzoic acid ligand (SBA) in compound 1.

FIG. 2A to FIG. 2D show 1D inorganic metal chain, 2D layered structure, pore size, and hydrogen bond of compound 1 respectively.

FIG. 3A and FIG. 3B show the results of thermogravimetric analysis and powder X-ray diffraction for compound 1 respectively.

FIG. 4A to FIG. 4D show the absorption/desorption of compound 1 for nitrogen gas, hydrogen gas, and carbon dioxide gas, and pore size analysis of compound 1 with HK method respectively.

FIG. 5A and FIG. 5B respectively show the structure of the asymmetric unit of compound 2 and the coordination environment of one 4,4′-sulfonyldibenzoic acid ligand (SBA) in compound 2.

FIG. 6A to FIG. 6D show 3D network structure, pore arrangement, pore size, and pore morphology and distribution of compound 2 respectively.

FIG. 7A and FIG. 7B respectively show the results of thermogravimetric analysis for compound 2 and 3.

FIG. 7C and FIG. 7D respectively show the results of powder X-ray diffraction for compound 2 and 3.

FIG. 8A to FIG. 8D respectively show the absorption/desorption of compound 2 for nitrogen gas, hydrogen gas, and carbon dioxide gas, and pore size analysis of compound 2 with HK method.

FIG. 8E to FIG. 8H respectively show the absorption/desorption of compound 2 for nitrogen gas, hydrogen gas, and carbon dioxide gas, and pore size analysis of compound 2 with HK method.

FIG. 9A and FIG. 9B respectively show the structure of the asymmetric unit of compound 4 and the coordination environment of one 4,4′-sulfonyldibenzoic acid ligand (SBA) in compound 4.

FIG. 10A to FIG. 10D show 1D inorganic metal chain, 2D layered structure, 2D structure after removing water of crystallization, and pore size of compound 4 respectively.

FIG. 11A and FIG. 11B show the results of thermogravimetric analysis and powder X-ray diffraction for compound 4 respectively.

FIG. 12A and FIG. 12B respectively show the structure of the asymmetric unit of compound 5 and the coordination environment of one 4,4′-sulfonyldibenzoic acid ligand (SBA) in compound 5.

FIG. 13A to FIG. 13D show 1D inorganic metal chain, 2D layered structure, pore size, and hydrogen bond of compound 5 respectively.

FIG. 14A and FIG. 14B show the results of thermogravimetric analysis and powder X-ray diffraction for compound 5 respectively.

### DESCRIPTION OF THE PREFERRED EMBODIMENT

The detailed description of the present invention will be discussed in the following embodiments, which are not intended to limit the scope of the present invention, and can be adapted for other applications. While drawings are illustrated in detail, it is appreciated that the quantity of the disclosed components may be greater or less than that disclosed, except where expressly restricting the amount of the components.

In this invention, five novel metal (II) coordination polymers (or MOFs) are synthesized by the hydrothermal method or the microwave syntheses method, in which alkaline-earth metal (II) ion magnesium (Mg), Calcium (Ca), or Strontium (Sr) or transition metal (II) ion Manganese (Mn) or Zinc (Zn) is used to be central metal and 4,4′-sulfonyldibenzoic acids (H₂SBA) are used to be organic ligands. These five novel metal (II) coordination polymers (or MOFs) are compound 1 [Mg₃(OH)₂(SBA)₂(EtOH)(H₂O)₃].3.5H₂O, compound 2 [Ca(SBA)].(H₂O), compound 3 [Sr(SBA)].0.5(H₂O), compound 4 [Mn(SBA)(EtOH)], and compound 5 [Zn₃(SBA)₂(OH)₂].EtOH. The structure characteristics of these five novel metal (II) coordination polymers (or MOFs) and synthesizing method therefore will be detailed in the following. The chemical structure of 4,4′-sulfonyldibenzoic acids (H₂SBA) is shown as follows:

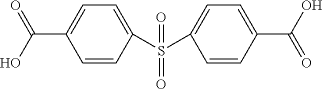 [SMILES: O=C(O)c1ccc(S(=O)(=O)c2ccc(C(=O)O)cc2)cc1]

### First Embodiment

Compound 1 has a formula [Mg₃(OH)₂(SBA)₂(EtOH)(H₂O)₃].3.5H₂O. Compound 1 is a 2D layered metal-organic framework (MOF) composed of divalent magnesium (Mg) ions and 4,4′-sulfonyldibenzoic acid groups (SBA), in which magnesium (Mg) ion is used to be central metal and SBA is used to be organic ligand. The result of single-crystal X-ray diffraction analysis shows that compound 1 is monoclinic and the space group of compound 1 is P2/c.

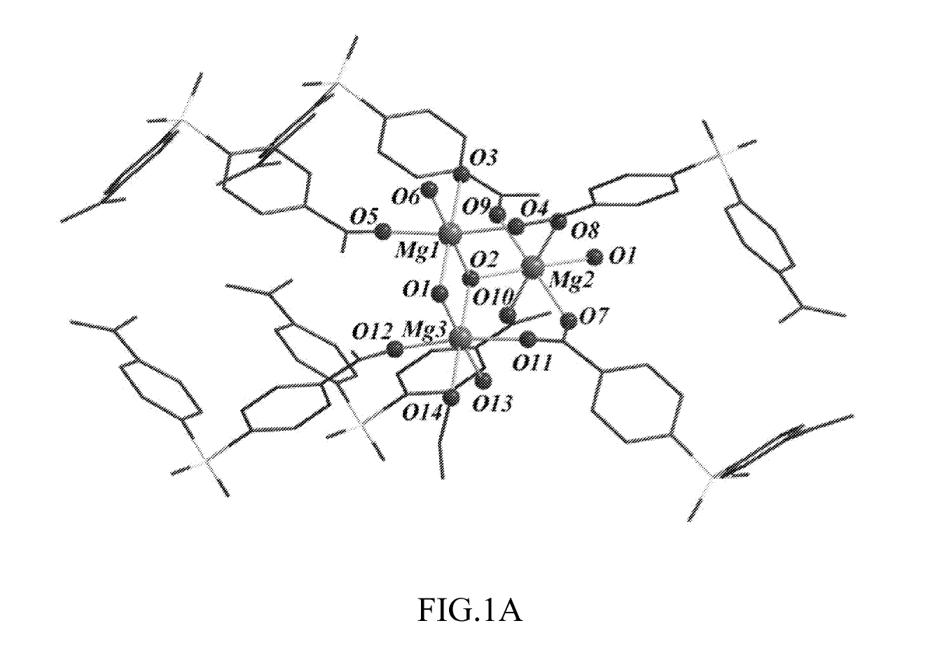

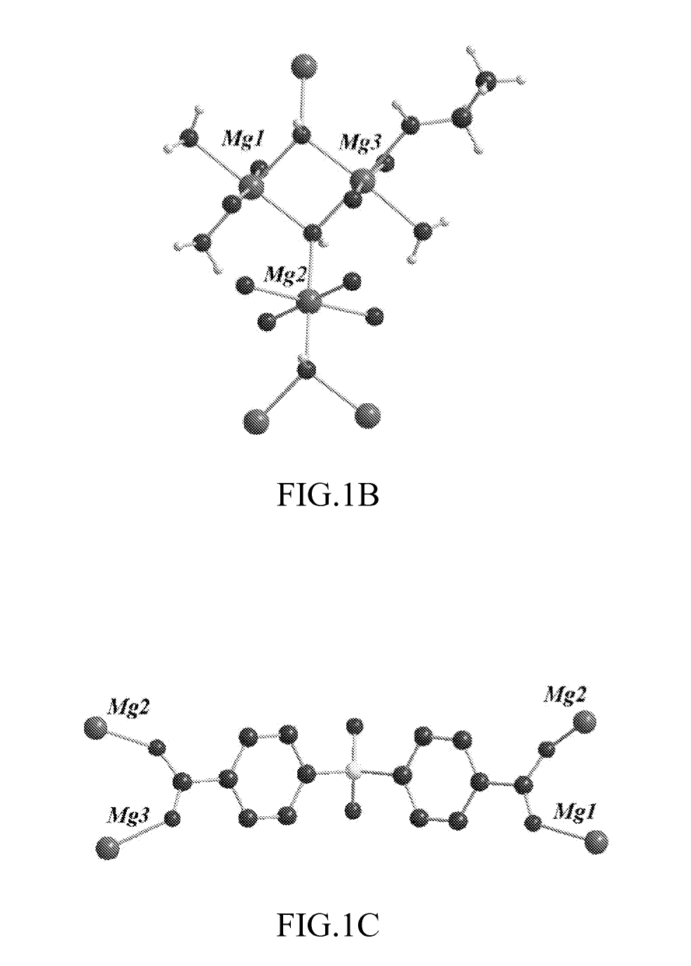

FIG. 1A shows one asymmetric unit of compound 1, which is coordination environment of Mg ion. Compound 1 is composed of a plurality of asymmetric units. FIG. 1B shows one simplified asymmetric unit of compound 1, in which the asymmetric unit shown in FIG. 1A is rotated at an angle and some organic ligands are omitted. Referring to FIG. 1A and FIG. 1B, the asymmetric unit comprises three Mg ions Mg(1), Mg(2), and Mg(3) to be the metal centers of the asymmetric unit. The Mg ion Mg(1) is six-coordinated and the Mg ion Mg(1) is coordinated with six oxygen atoms (O). Two of the six oxygen atoms are the oxygen atoms of the carboxyl groups (—COOH) of two SBA ligands, two of the six oxygen atoms are the oxygen atoms of two water molecules (H₂O), and the remaining two of the six oxygen atoms are the oxygen atoms of two hydroxyl groups (—OH). The Mg ion Mg(2) is six-coordinated and the Mg ions Mg(2) is coordinated with six oxygen atoms (O). Four of the six oxygen atoms are the oxygen atoms of the carboxyl groups (—COOH) of four SBA ligands, and the remaining of the six oxygen atoms are the oxygen atoms of two water molecules (H₂O). The Mg ion Mg(3) is six-coordinated and the Mg ions Mg(3) is coordinated with six oxygen atoms (O). Two of the six oxygen atoms are the oxygen atoms of the carboxyl groups (—COOH) of two SBA ligands, one of the six oxygen atoms is the oxygen atoms of one water molecules (H₂O), one of the six oxygen atoms is the oxygen atoms of one ethanol (EtOH), and the remaining two of the six oxygen atoms are the oxygen atoms of two hydroxyl groups (—OH). The three Mg ions Mg(1), Mg(2), and Mg(3) share one hydroxyl groups (—OH). The Mg—O bond lengths in the asymmetric unit are shown in Table 1.

TABLE 1

| | | | |
|---|---|---|---|
| Mg1-O(1) | 2.054(2) | Mg1-O(2) | 2.063(2) |
| Mg1-O(5) | 2.079(2) | Mg1-O(4) | 2.095(2) |
| Mg1-O(3) | 2.115(2) | Mg1-O(6) | 2.127(2) |
| Mg2-O(1) | 2.049(2) | Mg2-O(2)#2 | 2.057(2) |
| Mg2-O(9) | 2.083(2) | Mg2-O(8) | 2.090(2) |
| Mg2-O(10) | 2.099(2) | Mg2-O(7) | 2.109(2) |
| Mg3-O(2) | 2.057(2) | Mg3-O(1) | 2.058(2) |
| Mg3-O(12) | 2.077(2) | Mg3-O(11) | 2.087(2) |
| Mg3-O(13) | 2.109(2) | Mg3-O(14) | 2.117(2) |

Symmetry transformations used to generate equivalent atoms:
#2 x, y + 1, z

FIG. 1C shows the coordination environment of one 4,4′-sulfonyldibenzoic acid ligand (SBA) in compound 1. According to FIG. 1C, coordination environment of each 4,4′-sulfonyldibenzoic acid ligand (SBA) is μ₄-bridge ligand. Each of 4,4′-sulfonyldibenzoic acid ligands (SBA) has four oxygen atoms (O) coordinated with four Mg ions respectively.

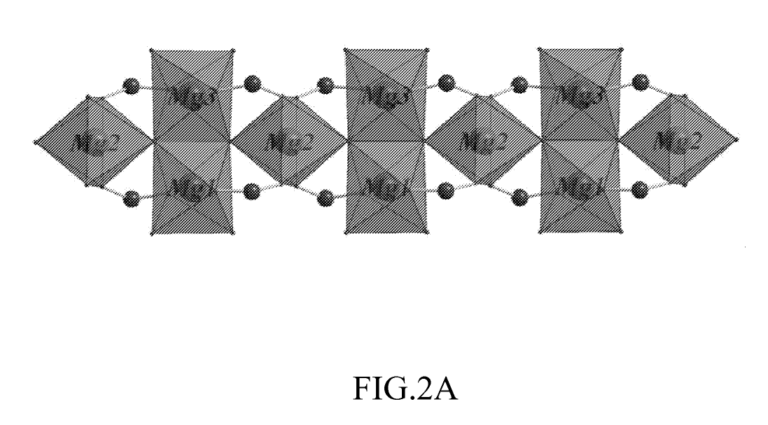

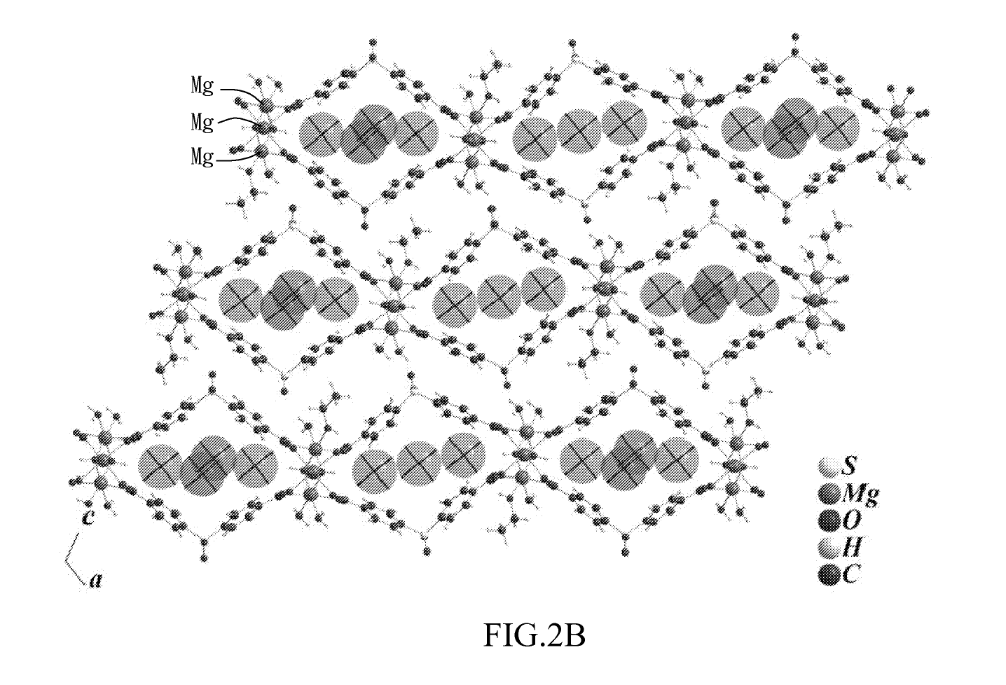

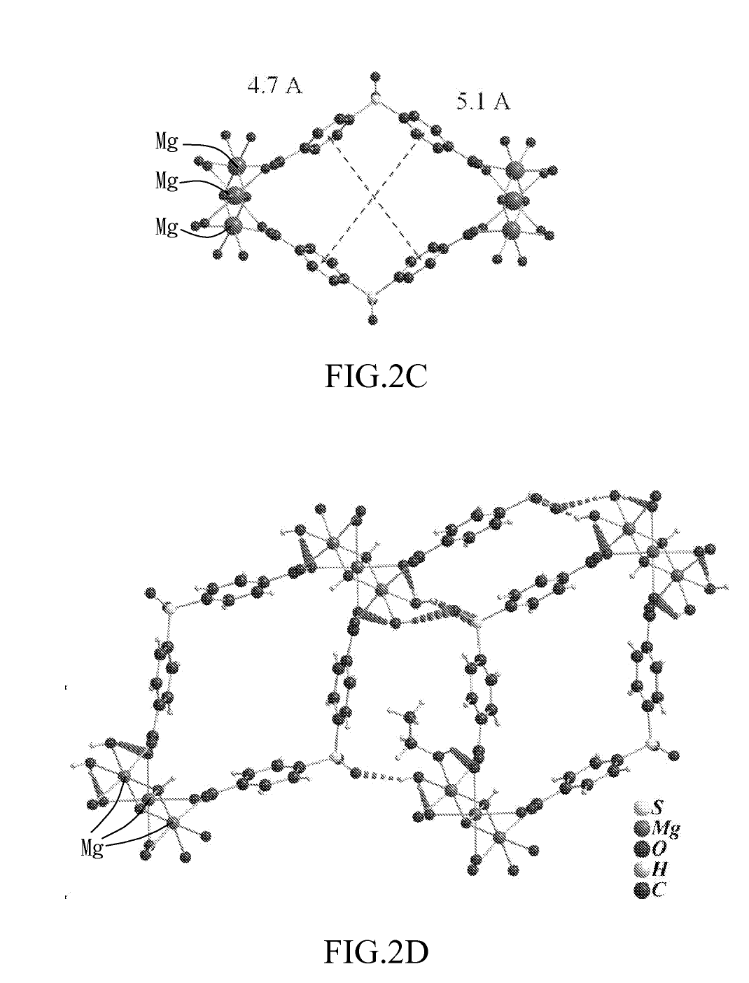

Compound 1 is a 2D layered metal-organic framework (MOF). In Compound 1, [MgO₆]octahedron is accomplished by central metal Mg and oxygen atoms, and a 1D inorganic chain is formed by sharing points and edges of [MgO₆]octahedron with each other as FIG. 2A shows. This 1D inorganic chain is bonded to the O—C—O groups of the SBA to form a 2D layered structure as FIG. 2B shows. FIG. 2B shows the 2D structure in view in [010] direction, and the circle patterns in the pores are solvent molecules. The 2D layered structures are bonded with each other by hydrogen bonds, which is caused by the hydrogen atoms of the coordinated water, to form a 3D network structure as FIG. 2D shows. In FIG. 2D, the dotted lines represent the hydrogen bonds. The pores in compound 1 are shown in FIG. 2C. After one coordinated ethanol molecule (EtOH), three one coordinated water molecules, and three and half water of crystallization are removed from one pore, the cross-section area of the 1D channel along b axis is 5.1×4.7 Å² (utilizing the length of the connecting line between two center points of two benzene rings). The van der waals radius of atoms have been omitted in the cross-section area figured herein. The pore size, which is figured out by PLATON method after removing of solvent, is 903.9 Å³, and the volume of the pores occupies 22.2% crystal volume of the compound 1.

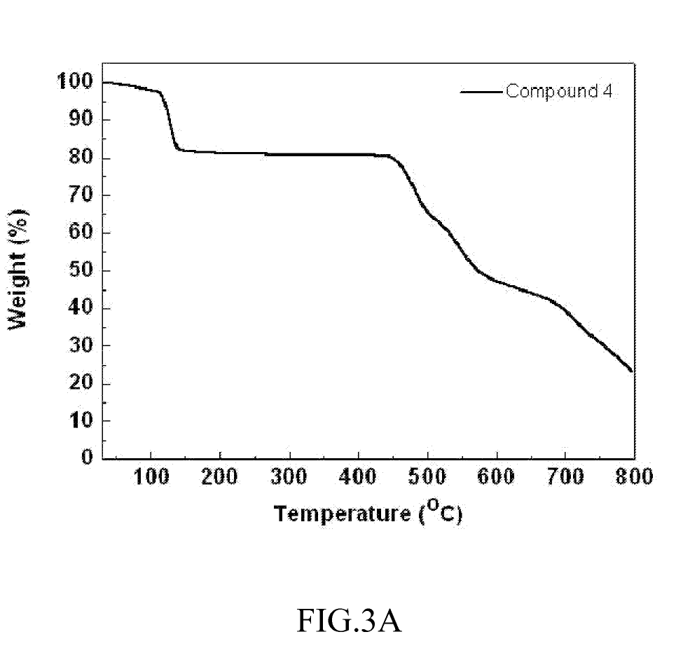

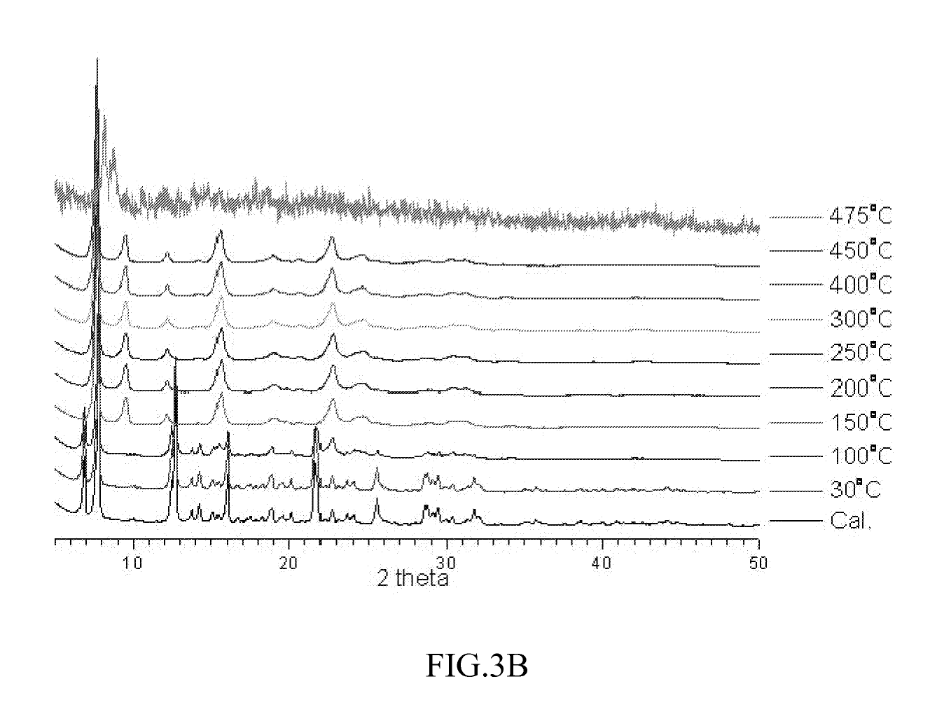

The result of thermogravimetric analysis for compound 1 by thermogravimetric analyzer (TAG) is shown in FIG. 3A. Referring FIG. 3A, by observing the weight loss curve, it is found that the first heat loss of compound 1 is occurred at 50° C-150° C. and about 17.9% weight of compound 1 is lost at 50° C-150° C. Therefore, it is recognized that one coordinated ethanol, three coordinated water, and three and half water of crystallization are removed in this stage (Cal. 3EtOH+6.5H₂O, 18.7%). After, there is on any heat loss of compound 1 until 430° C. At 430° C., the structure of compound 1 begins to decompose (Cal. SBA, 69.6%). Therefore, after removing the solvent (in other words, after 150° C.), the structure of compound 1 is changed and so the pores are formed in compound 1.

The result of powder X-ray diffraction analysis for compound 1 by a SHIMADZU XRD-6000 automated powder diffractometer is shown in FIG. 3B. Referring to FIG. 3B, by observing the powder X-ray, it is found that at 150° C., there is a characteristic peak occurring at the position in which 2 theta equals to 9. Accordingly, it is recognized that the structure of compound 1 is changed when coordinated water and ethanol are removed from compound 1. At this time, the changed structure of compound 1 has the formula [Mg₃(OH)₂(SBA)₂].3H₂O and compound 1 begins to decompose at 475° C.

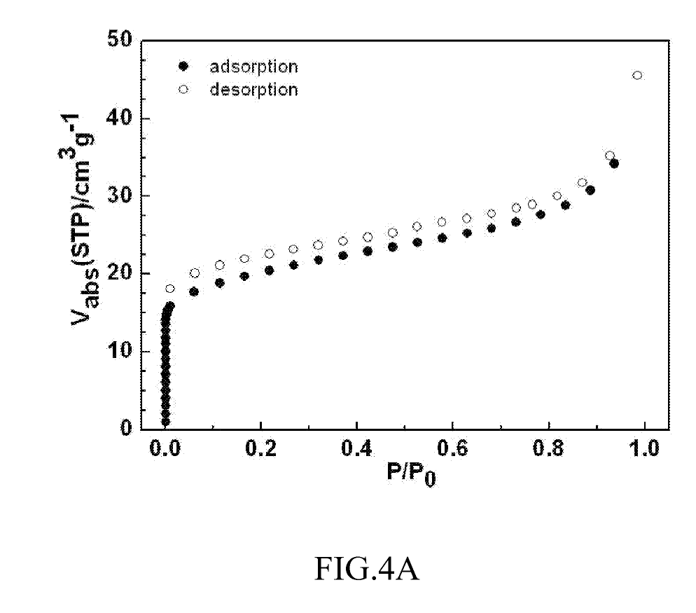

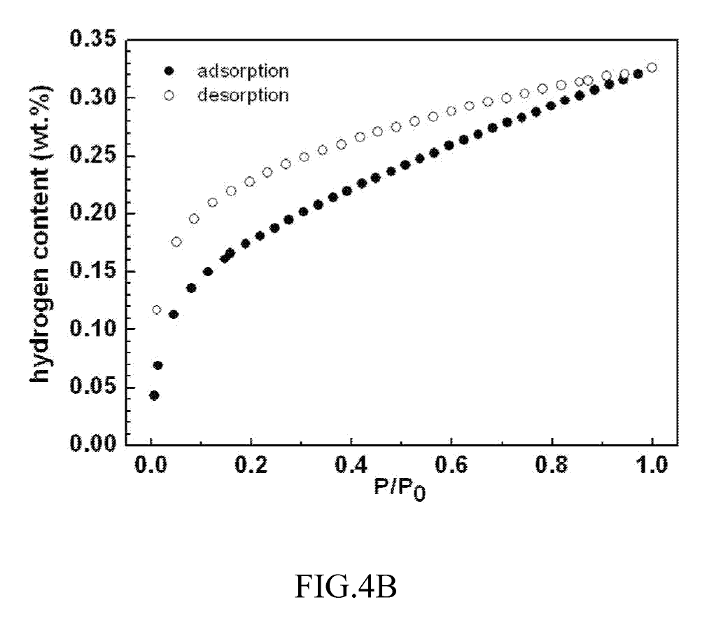

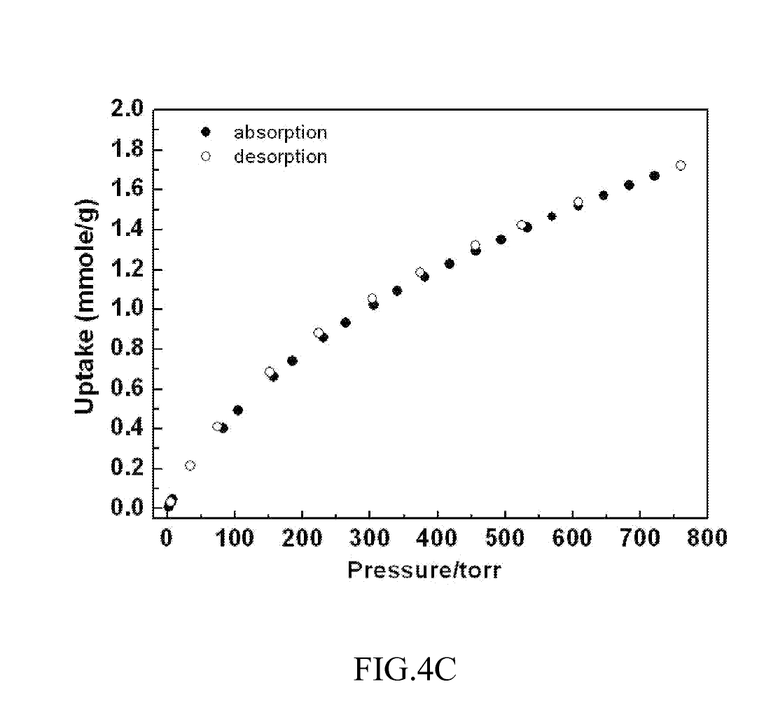

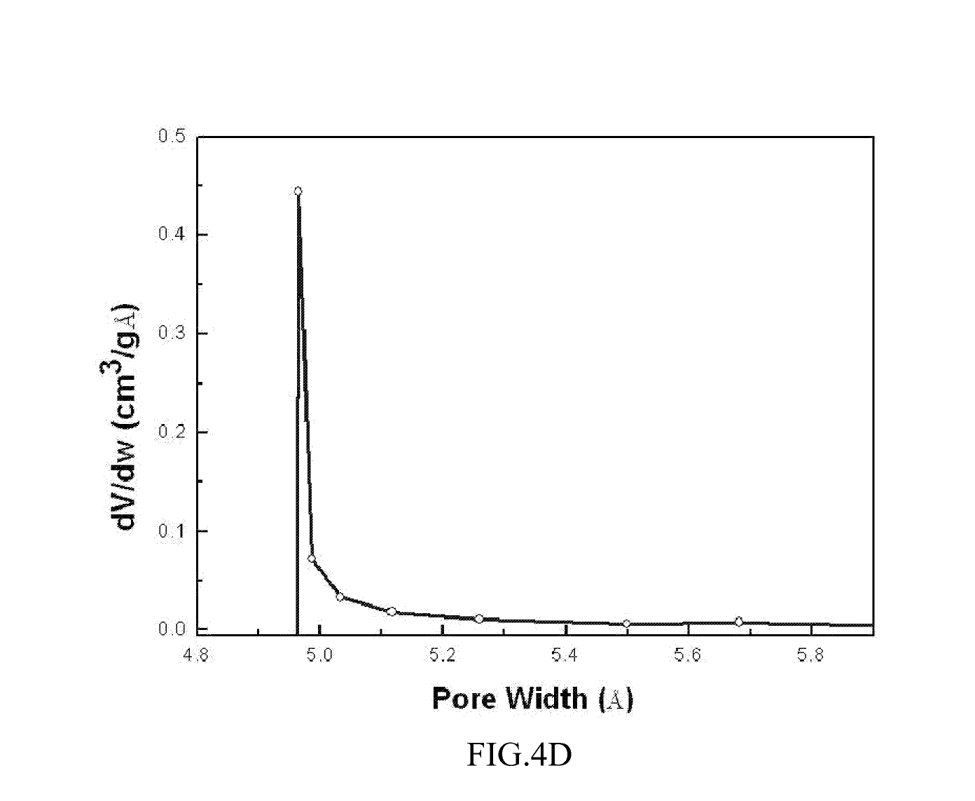

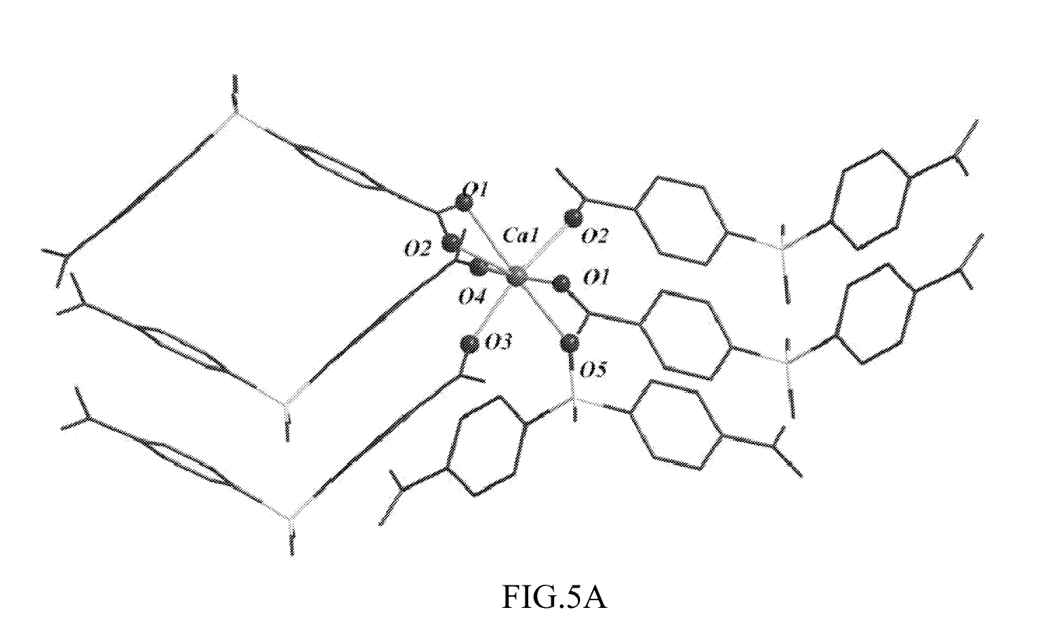

The result of the absorption/desorption of compound 1 for nitrogen gas, hydrogen gas, and carbon dioxide gas, and pore size analysis of compound 1 with HK method by a ASAP-2020 BET are respectively shown in FIG. 4A to FIG. 4D. The operation and condition for the test of absorption/desorption of compound 1 showing in follow: About 150 mg of the crystal of compound 1 is taken to grind into powders, and then, the powders are put into a sample tube. After, the surplus water and the coordinated solvent in the sample are removed by vacuuming (˜10⁻³ torr) the sample tube at 150° C. for 36 hours. The absorption/desorption of the sample (compound 1) is increased few with increasing of vacuuming time. And then, the sample is dipped into liquid nitrogen and the absorption/desorption (cm³/g) of the sample for nitrogen gas is measured by the volume method. The measuring range is 1.00×10⁻³≦p/oₒ≦1.00. Referring to FIG. 4A, it shows the absorption isotherm of compound 1 for nitrogen gas, in which the absorption for nitrogen gas is the y axis and the p/pₒ is the x axis. When at 77 K, degassing for 36 hours, and p/pₒ=1, the absorption of compound 1 for nitrogen gas is 34.22 cm³/g. The specific surface areas calculated by HK method and Iangmuir method with this absorption site (or the value of the absorption site) are 70 m²/g and 86 m²/g. By observing the absorption/desorption curve of compound 1 for nitrogen gas, it is recognized that the pores morphology of compound 1 is Type I micropores morphology. After the result of the absorption/desorption of compound 1 for nitrogen gas is calculated by HK method, it is recognized that the pore size of compound 1 is 5.1×4.7 Å², as FIG. 4D shows. Also, the absorption/desorption curve of compound 1 for nitrogen gas can prove that the compound 1 is a porous material (metal-organic framework; MOF).

Referring to FIG. 4B, it shows the absorption isotherm of compound 1 for hydrogen gas, in which the absorption for hydrogen gas is the y axis and the p/pₒ is the x axis. When at 77 K, degassing for 36 hours, and p/pₒ=1, the absorption of compound 1 for hydrogen gas is 0.32 wt %. Referring to FIG. 4C, it shows the absorption isotherm of compound 1 for carbon dioxide gas, in which the absorption for carbon dioxide gas is the y axis and the p/pₒ is the x axis. When at 293 K, degassing for 36 hours, and pressure/torr=760, the absorption of compound 1 for carbon dioxide gas is 1.71 mmol/g.

Compound 1 can be synthesized by hydrothermal method or microwave syntheses method. In both of the two methods, a reactor comprises a Teflon inner cup and iron outer cup is utilized to synthesizing Compound 1. The difference between hydrothermal method and microwave syntheses method is that the reactor is put into a high temperature furnace for synthesizing in the hydrothermal method but the reactor is put into a microwave reactor for synthesizing in the microwave syntheses method. The hydrothermal method for synthesizing compound 1 is detailed as the following: First, 0.205 g (0.8 mmol) Mg(NO₃)₂.6H₂O, 0.0612 g (0.2 mmol) 4,4′-sulfonyldibenzoic acid (H₂SBA), 5.0 mL ethanol (EtOH), and 1.0 mL water (H₂O) are put into the Teflon inner cup in order. And then, the Teflon inner cup is put into the iron outer cup and the reactor is put into the high temperature furnace. In the high temperature furnace, the reactor (or the Mg(NO₃)₂.6H₂O, 4,4′-sulfonyldibenzoic acid (H₂SBA), ethanol (EtOH), and water (H₂O) in the reactor) is heated to 150° C. with 60° Ch⁻¹ and it is maintained at 150° C. for reacting for about 2 days. After, the reactor is cooled to room temperature with 6° Ch⁻¹. And then, compound 1 is gotten through suction filtration, washing with ethanol and water, and drying. The compound 1 is a transparent acicular crystal. The weight of the gotten compound 1 is 0.072 g, and the yield of the compound 1 is 41.2% by calculating with defining the 4,4¹-sulfonyldibenzoic acid (H₂SBA) as a limiting reagent. The weight of the Mg(NO₃)₂.6H₂O, 4,4′-sulfonyldibenzoic acid (H₂SBA), ethanol (EtOH), and water (H₂O) mentioned above are just taken as an example, and not limited to this. The weight of the Mg(NO₃)₂.6H₂O, 4,4′-sulfonyldibenzoic acid (H₂SBA), ethanol (EtOH), and water (H₂O) could be increased or decreased with the same ratio of weight mentioned above.

The microwave syntheses method for synthesizing compound 1 is detailed as the following: First, 0.410 g (0.16 mmol) Mg(NO₃)₂.6H₂O, 0.1224 g (0.4 mmol) 4,4′-sulfonyldibenzoic acid (H₂SBA), 7.0 mL ethanol (EtOH), and 3.0 mL water (H₂O) are put into the Teflon inner cup in order. And then, the Teflon inner cup is put into the iron outer cup and the reactor is put into the microwave reactor. In the microwave reactor, the output power of the microwave reactor is set to 400 W, and the reactor (or the Mg(NO₃)₂.6H₂O, 4,4′-sulfonyldibenzoic acid (H₂SBA), ethanol (EtOH), and water (H₂O) in the reactor) is heated to 180° C. with 60° Ch⁻¹. It is maintained at 180° C. for reacting for 20 minutes. After, the reactor is cooled to room temperature with 6° Ch⁻¹. And then, compound 1 is gotten through suction filtration, washing with ethanol and water, and drying. The weight of the Mg(NO₃)₂.6H₂O, 4,4′-sulfonyldibenzoic acid (H₂SBA), ethanol (EtOH), and water (H₂O) mentioned above are just taken as an example, and not limited to this. The weight of the Mg(NO₃)₂.6H₂O, 4,4′-sulfonyldibenzoic acid (H₂SBA), ethanol (EtOH), and water (H₂O) could be increased or decreased with the same ratio of weight mentioned above.

### Second Embodiment

Compound 2 has a formula [Ca(SBA)].(H₂O). Compound 2 is a 3D network metal-organic framework (MOF) composed of divalent Calcium (Ca) ions and 4,4′-sulfonyldibenzoic acid groups (SBA), in which Calcium (Ca) ion is used to be central metal and SBA is used to be organic ligand. Compound 3 has a formula [Sr(SBA)].0.5(H₂O). Compound 3 is a 3D network metal-organic framework (MOF) composed of divalent Strontium (Sr) ions and 4,4′-sulfonyldibenzoic acid groups (SBA), in which Strontium (Sr) ion is used to be central metal and SBA is used to be organic ligand. Compounds 2 and 3 have the same structure. The result of single-crystal X-ray diffraction analysis shows that compounds 2 and 3 are monoclinic and both of the space groups of compound 2 and 3 is P2₁/n.

Because compounds 2 and 3 have the same structure, the present invention only takes compound 2 as example to illustrate the structure of compound 2. Replacing the Calcium (Ca) ions in following description and drawings of the structure of compound 2 with Strontium (Sr) ions can get the structure of compound 3.

FIG. 5A shows one asymmetric unit of compound 2, which is coordination environment of Ca ion. Compound 2 is composed of a plurality of asymmetric units shown in FIG. 5A. Referring to FIG. 5A, the asymmetric unit comprises one Ca ion Ca(1) to be the metal center of the asymmetric unit. The Ca ion Ca(1) is seven-coordinated and the Ca ion Ca(1) is coordinated with seven oxygen atoms (O). The seven oxygen atoms are the oxygen atoms of the carboxyl groups (—COOH) of six SBA ligands. FIG. 5B shows the coordination environment of one 4,4′-sulfonyldibenzoic acid ligand (SBA) in compound 2. According to FIG. 5B, coordination environment of each 4,4′-sulfonyldibenzoic acid ligand (SBA) is μ₆-bridge ligand. Each of 4,4′-sulfonyldibenzoic acid ligands (SBA) has five oxygen atoms (O) coordinated with six Ca ions respectively. Compound 3 has the same structure with compound 2. The Ca—O bond lengths in the asymmetric unit of compound 2 are shown in Table 2, and the Sr—O bond lengths in the asymmetric unit of compound 3 are shown in Table 3.

TABLE 2

| | | | |
|---|---|---|---|
| Ca(1)-O(3) | 2.298(14) | Ca(1)-O(4) | 2.300(15) |
| Ca(1)-O(2) | 2.359(14) | Ca(1)-O(1) | 2.376(14) |
| Ca(1)-O(1)#1 | 2.438(14) | Ca(1)-O(5) | 2.455(13) |
| Ca(1)-O(2)#2 | 2.885(15) | | |

Symmetry transformations used to generate equivalent atoms:
#1 −x + 1/2, y + 1/2, −z + 1/2
#2 −x + 1/2, y − 1/2, −z + 1/2

TABLE 3

| | | | |
|---|---|---|---|
| Sr(1)-O(2) | 2.492(2) | Sr(1)-O(1) | 2.437(2) |
| Sr(1)-O(4) | 2.493(2) | Sr(1)-O(3) | 2.516(2) |
| Sr(1)-O(4)#1 | 2.571(2) | Sr(1)-O(5) | 2.589(2) |
| Sr(1)-O(3)#2 | 2.932(2) | | |

Symmetry transformations used to generate equivalent atoms:
#1 −x + 1/2, y − 1/2, −z + 3/2
#2 −x + 1/2, y + 1/2, −z + 3/2

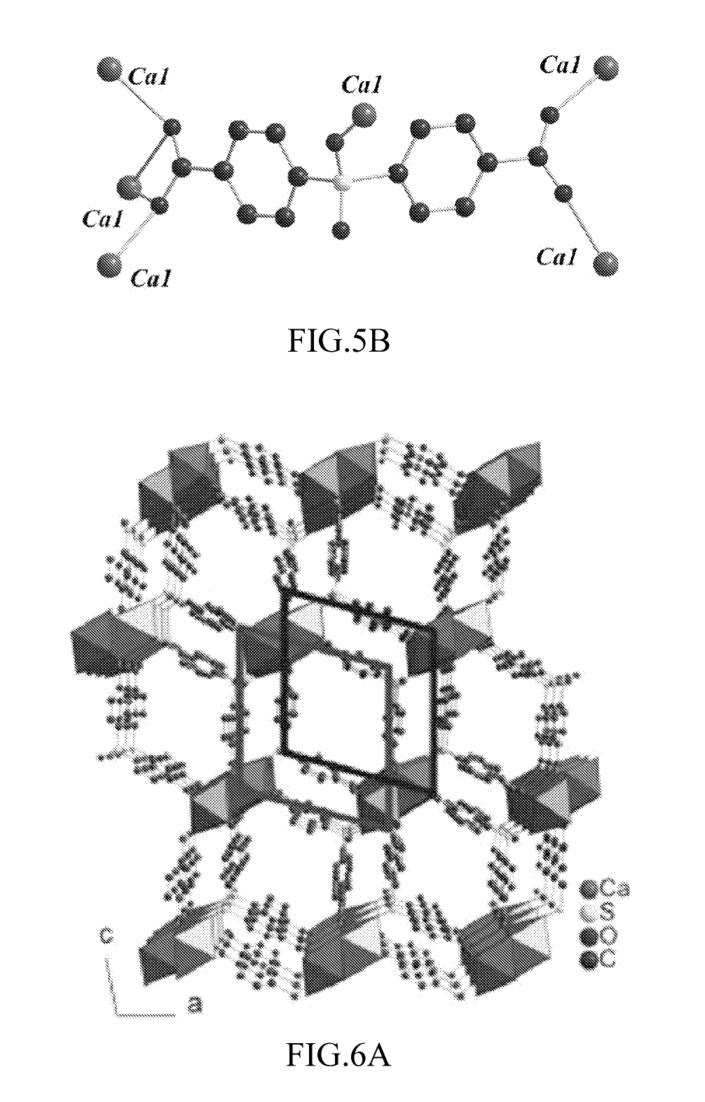

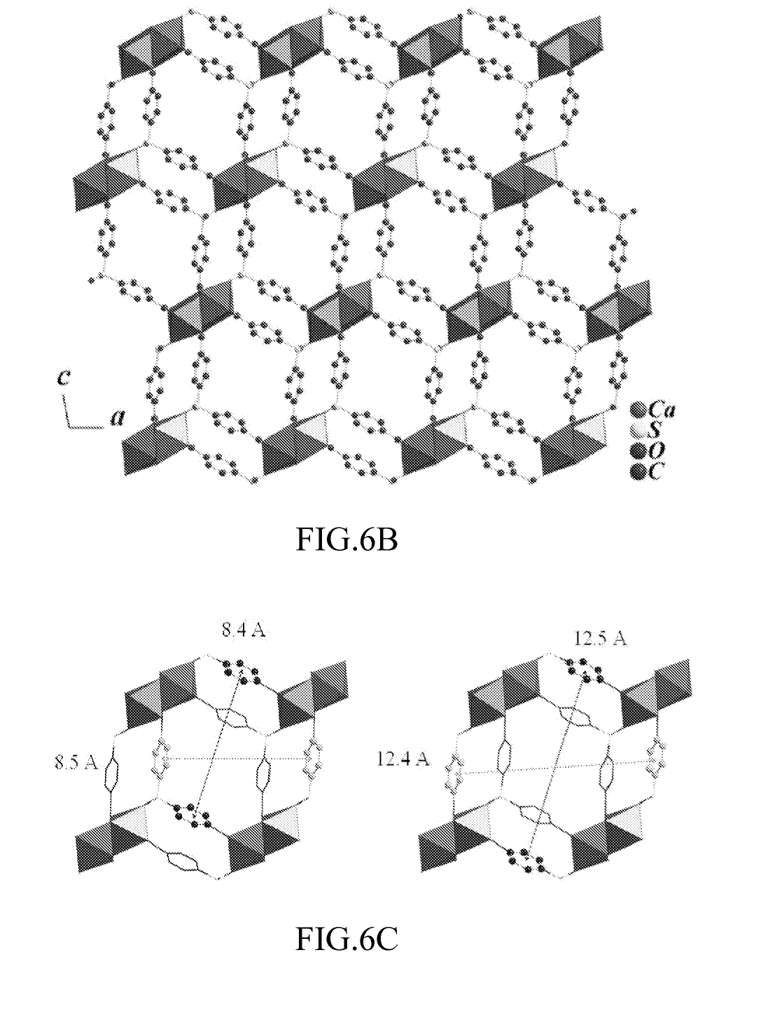

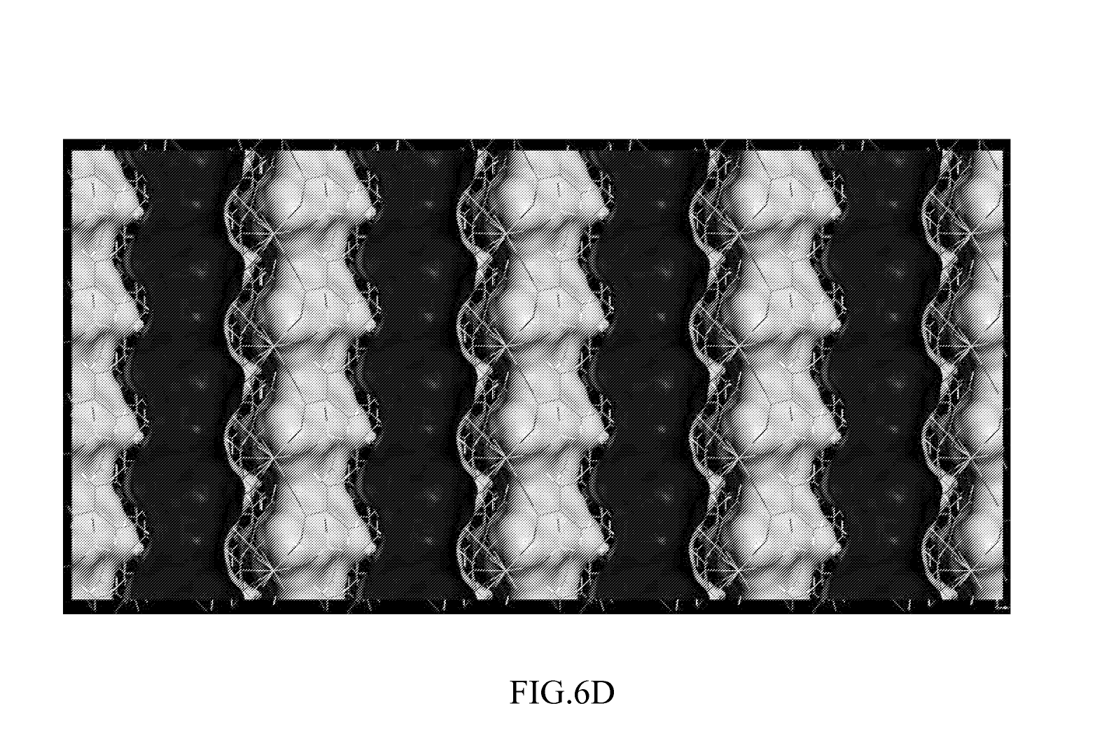

Both of compounds 2 and 3 are a 3D network metal-organic framework (MOF). Taking compound 2 as an example, in Compound 2, [CaO₇] mono-capped octaheral is accomplished by central metal Mg and oxygen atoms, and a 1D inorganic chain is formed by sharing points and edges of [CaO₇] mono-capped octaheral with each other. This 1D inorganic chain is bonded to the O—C—O groups of the SBA to form a 3D network structure as FIG. 6A shows. FIG. 6A shows 1D inorganic chain and the 3D structure of compound 2 in view in [100] direction. FIG. 6B shows the pore arrangement of compound 2 in view in [010] direction. FIG. 6C shows the pores of compound 2. After water of crystallization are removed from one pore of compound 2, the cross-section areas of the 1D channel along b axis is 8.4×8.5 Å² and 12.4×12.5 Å² (utilizing the length of the connecting line between two center points of two benzene rings) as FIG. 6C shows. The van der waals radius of atoms have been omitted in the cross-section area figured herein. The pore size of compound 2, which is figured out by PLATON method after removing of solvent, is 259.7 Å³, and the volume of the pore occupies 17.6% crystal volume of the compound 2. After water of crystallization are removed from one pore of compound 3, the cross-section area of the 1D channel along b axis is 8.7×8.6 Å² (utilizing the length of the connecting line between two center points of two benzene rings). The van der waals radius of atoms have been omitted in the cross-section area figured herein. The pore size of compound 3, which is figured out by PLATON method after removing of solvent, is 303.8 Å³, and the volume of the pores occupies 19.2% crystal volume of the compound 3. Referring to FIG. 6D, it shows the pore morphology and distribution of compounds 2 and 3 in view in [010] direction. The structures of compounds 2 and 3 have rhomboidal pores, the pore paths are staggered throughout the structures of compounds 2 and 3 as FIG. 6D shows. In the structures of compounds 2 and 3, benzene rings are staggered and the water crystallization in the pores shows the pore paths and the gray portions surrounded by compound 2 (or compound 3) in FIG. 6D shows the water crystallization in the pores (or the pore paths). The 3D structures of compound 2 and 3 are uninodal net or 6-connected net according to topological analyses. It can be found through Reticular Chemistry Structure Resource. Both point symbols of the structures of compound 2 and compound 3 are {4¹²,6³}, so they are pcu type in topology.

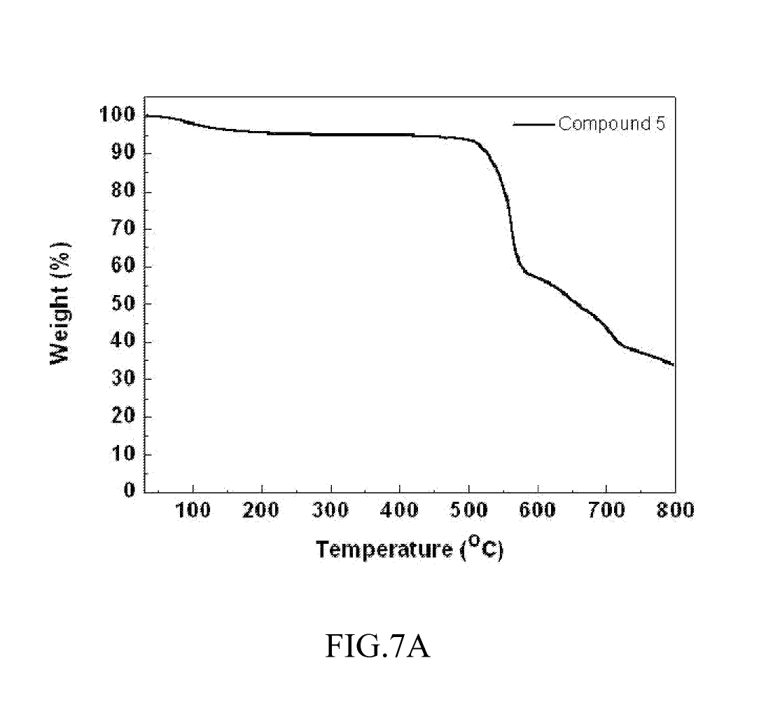

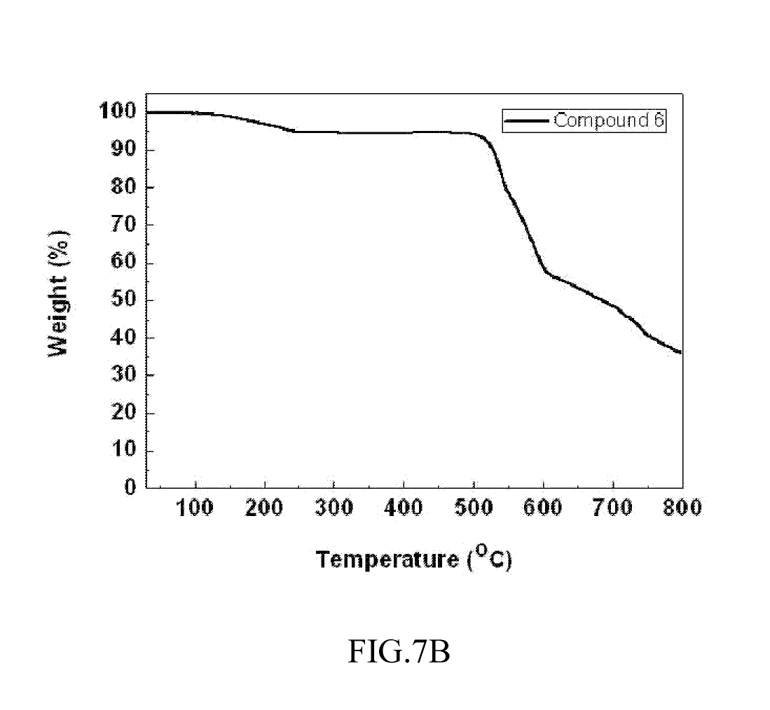

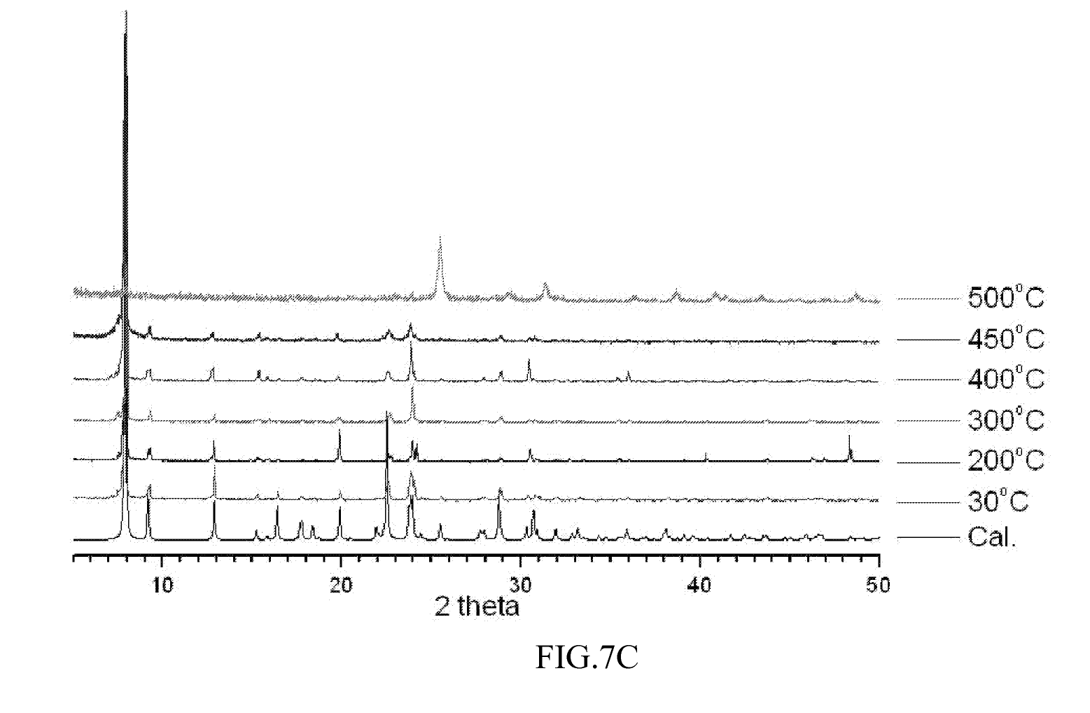

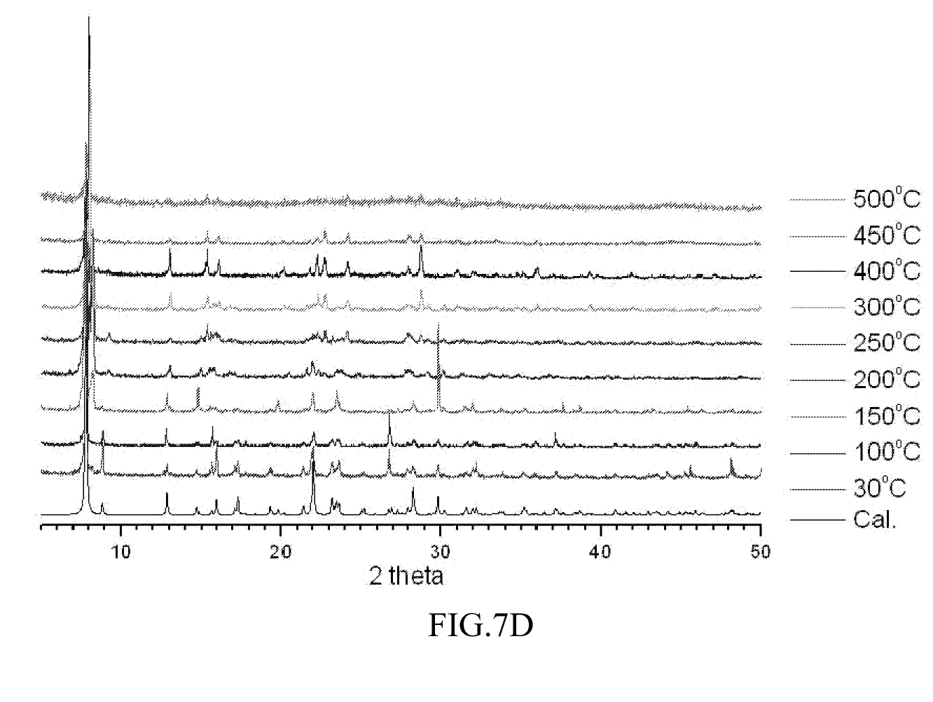

The result of thermogravimetric analysis for compounds 2 and 3 by thermogravimetric analyzer (TAG) are shown in FIG. 7A and FIG. 7B respectively. Referring to FIG. 7A, by observing the weight loss curve, it is found that the first heat loss of compound 2 is occurred at 50° C-170° C. and about 5.1% weight of compound 2 is lost at 50° C-170° C. Therefore, it is recognized that one water of crystallization are removed in this stage (Cal. H₂O, 6.8%). After, there is on any heat loss of compound 2 until about 450° C. At 800° C., the structure of compound 2 begins to decompose (Cal. SBA, 84.4%). Therefore, after removing the solvent (in other words, after 170° C.), the structure of compound 2 is changed and so the pores are formed in compound 2.

Referring to FIG. 7B, by observing the weight loss curve, it is found that the first heat loss of compound 3 is occurred at 50° C-240° C. and about 5.4% weight of compound 3 is lost at 50° C-240° C. Therefore, it is recognized that half water of crystallization are removed in this stage (Cal. 0.5 H₂O, 2.3%). After, there is on any heat loss of compound 3 until about 470° C. At 800° C., the structure of compound 3 begins to decompose (Cal. SBA, 76.3%). Therefore, after removing the solvent (in other words, after 100° C.), the structure of compound 3 is changed and so the pores are formed in compound 3.

The result of powder X-ray diffraction analysis for compounds 2 and 3 by a SHIMADZU XRD-6000 automated powder diffractometer is shown in FIG. 7C and FIG. 7D. Referring to FIG. 7C, by observing the powder X-ray, it is found that the structure of compound 2 is not changed when water of crystallization are removed from compound 2. At this time, performing powder X-ray diffraction analysis for compounds 2, it is found that the structure of compound 2 has the formula [Ca(SBA)] and compound 2 begins to decompose at 450° C. Referring to FIG. 7D, by observing the powder X-ray, it is found that when water of crystallization are removed from compound 3 at 100° C., a shift is occurred at the position in which 2 theta equals to 8.9 and a split is occurred at the position in which 2 theta equals to 7.9. Therefore, it is recognized that the structure of compound 3 is twisted and unstable when water of crystallization are removed from compound 3. Performing powder X-ray diffraction analysis for compounds 3 at 200° C., it is found that the structure of compound has the formula [SrSBA] and compound 3 begins to decompose at 450° C.

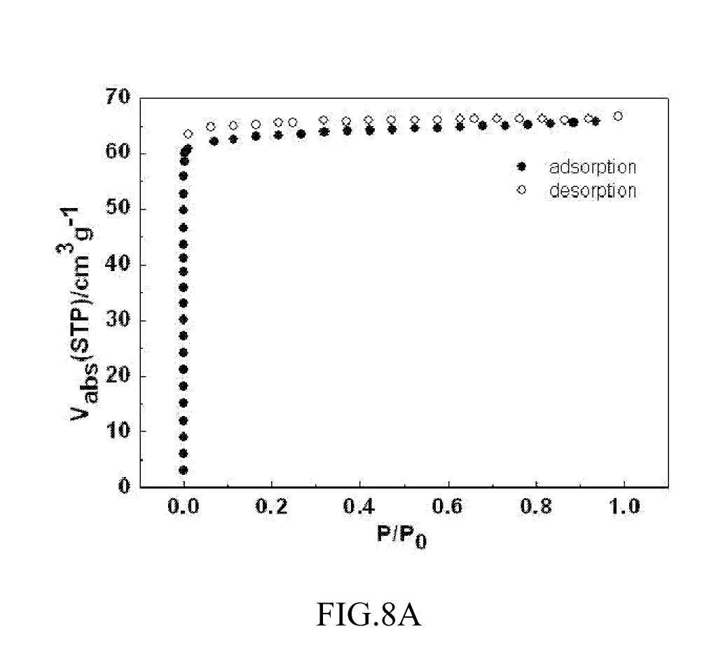

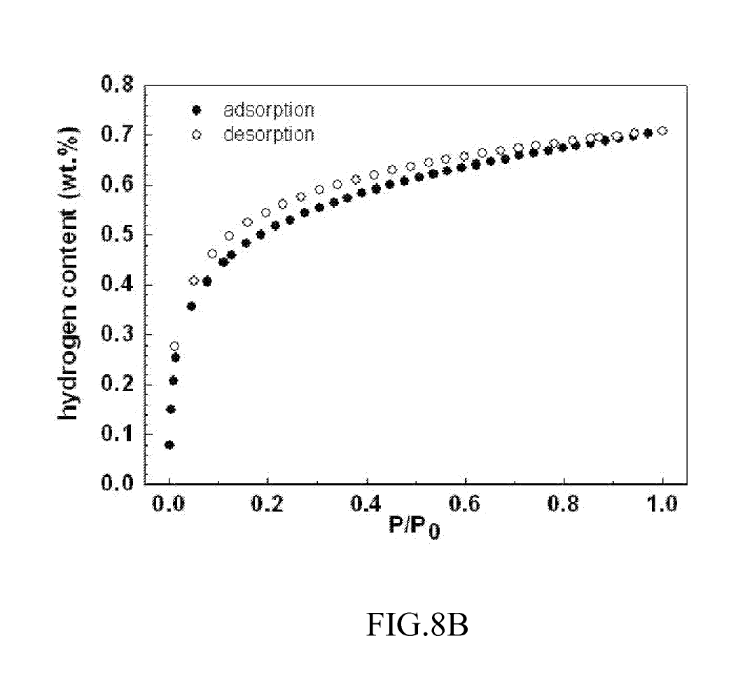

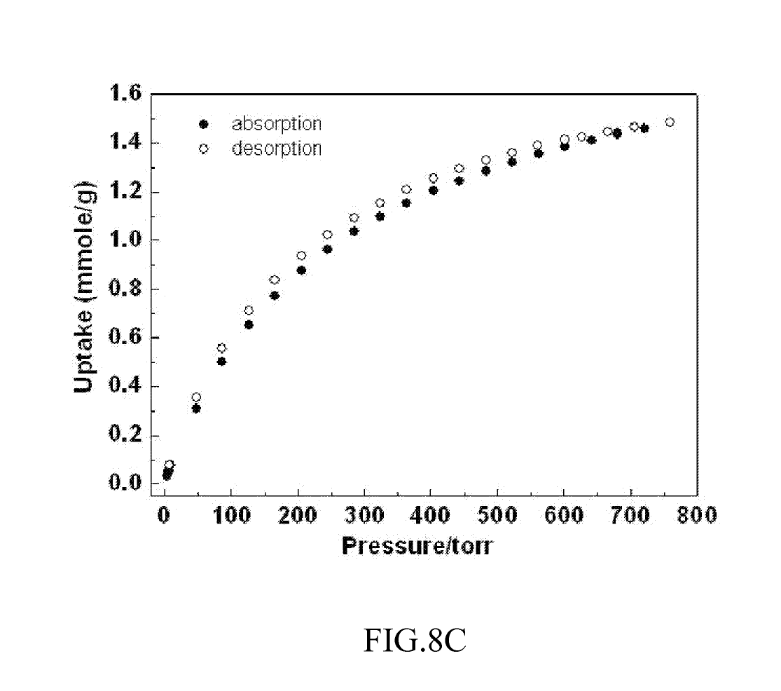

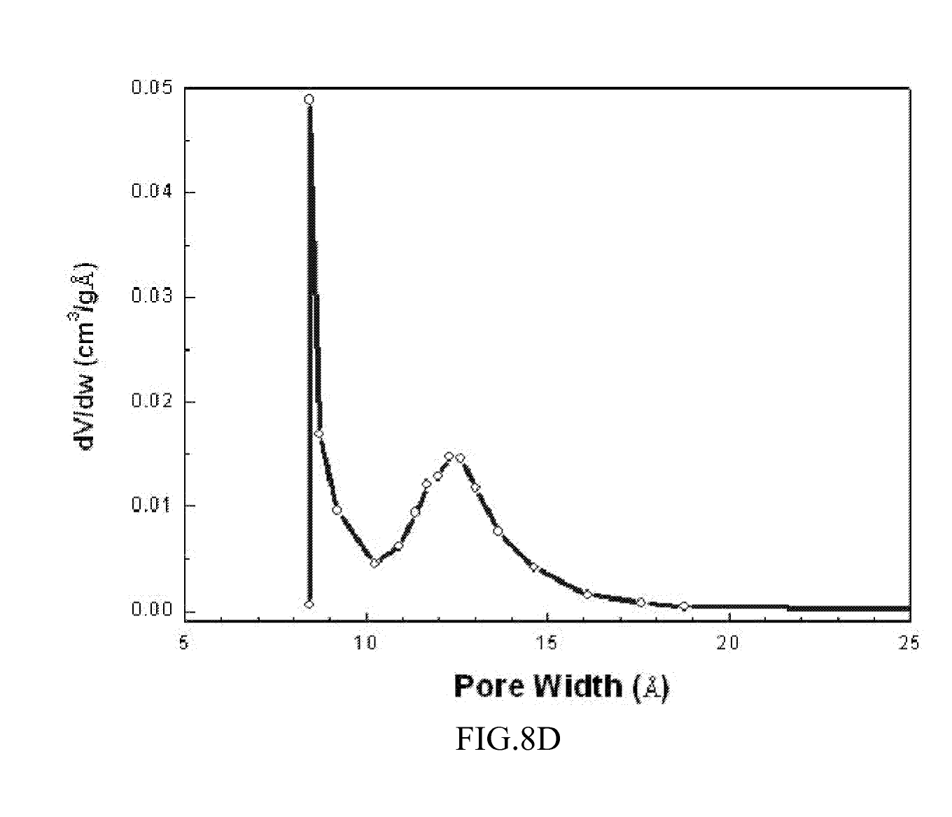

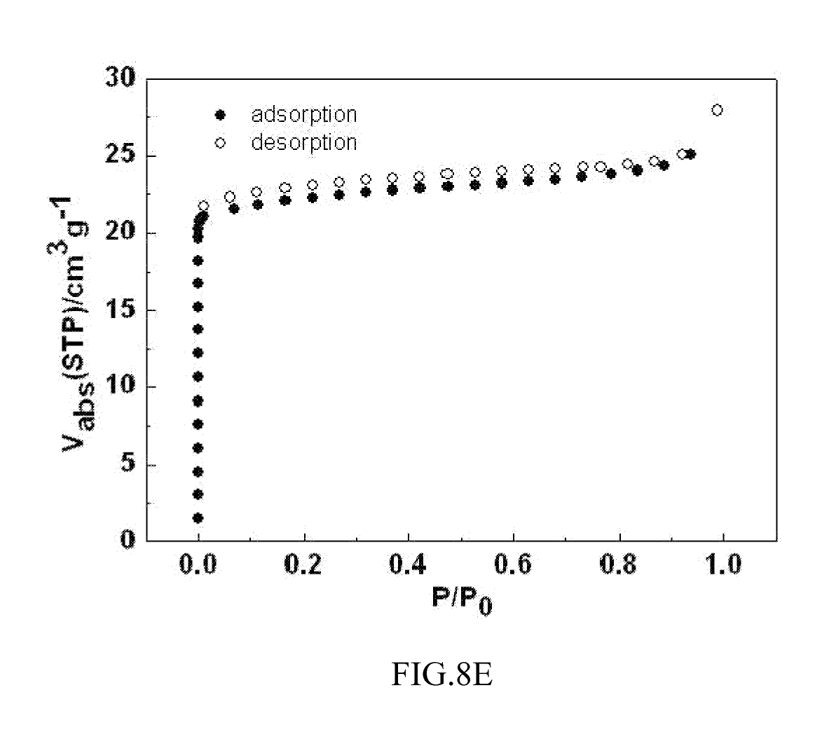

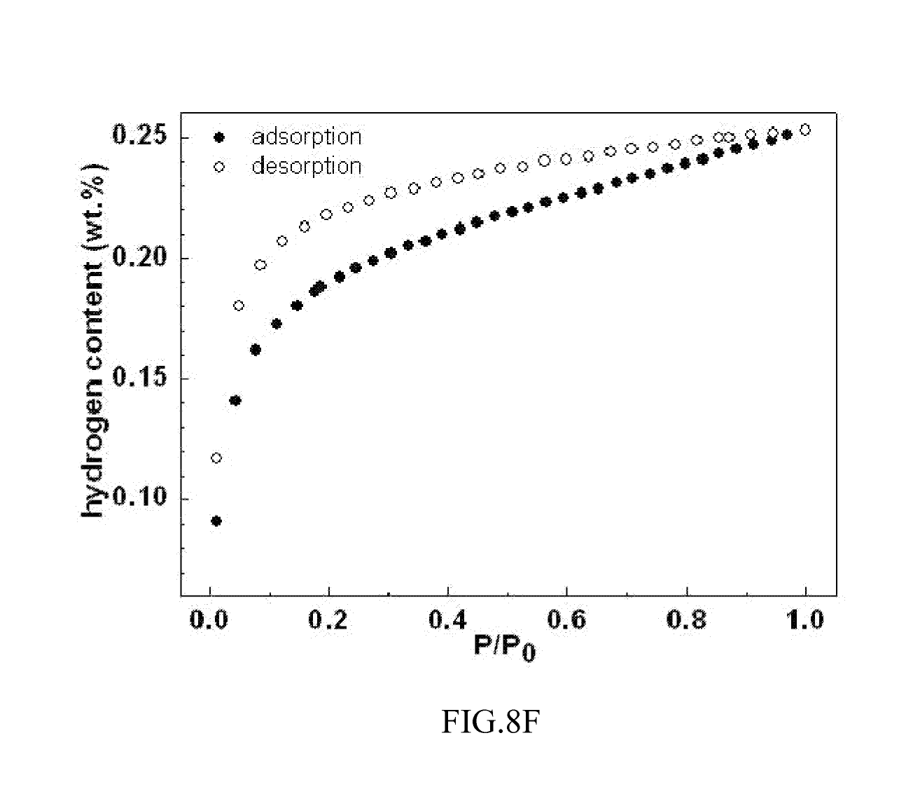

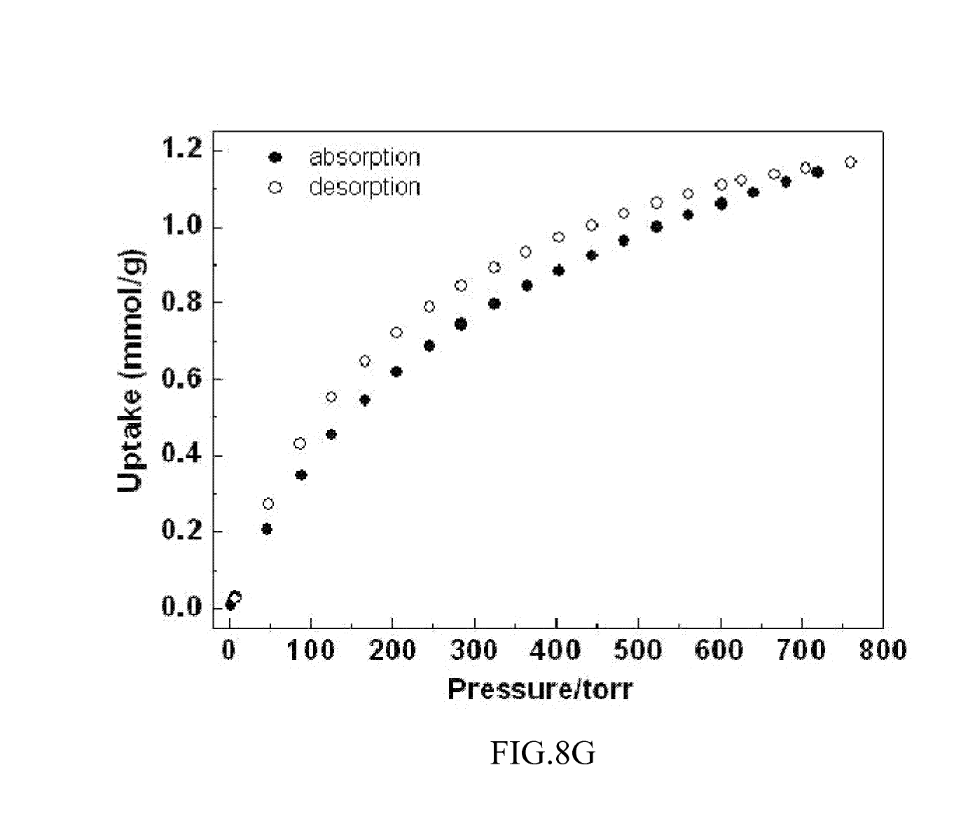

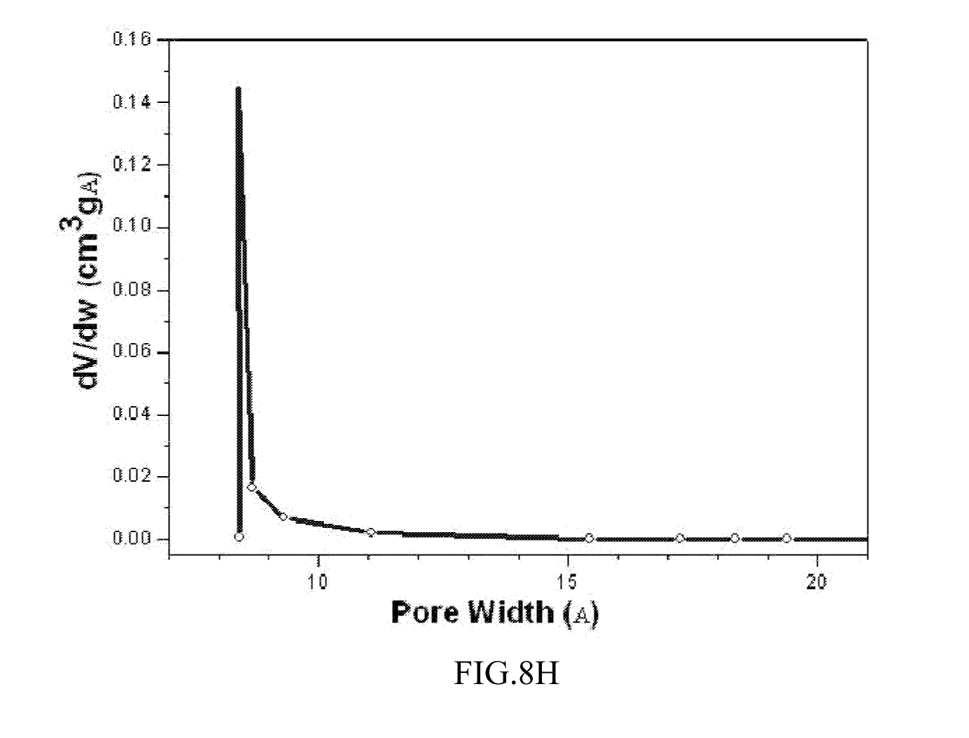

The result of the absorption/desorption of compound 2 for nitrogen gas, hydrogen gas, and carbon dioxide gas, and pore size analysis of compound 2 with HK method by a ASAP-2020 BET are respectively shown in FIG. 8A to FIG. 8D. The operation and condition for the test of absorption/desorption of compound 2 showing in follow: About 150 mg of the crystal of compound 2 is taken to grind into powders, and then, the powders are put into a sample tube. After, the surplus water and the coordinated solvent in the sample are removed by vacuuming (˜10⁻³ torr) the sample tube at 150° C. for 24 hours and 36 hours. The absorption/desorption of the sample (compound 2) is increased few with increasing of vacuuming time. And then, the sample is dipped into liquid nitrogen and the absorption/desorption (cm³/g) of the sample for nitrogen gas is measured by the volume method. The measuring range is 1.00×10⁻³≦p/pₒ≦1.00. Referring to FIG. 8A, it shows the absorption isotherm of compound 2 for nitrogen gas, in which the absorption for nitrogen gas is the y axis and the p/pₒ is the x axis. When at 77 K, degassing for 36 hours, and p/pₒ=1, the absorption of compound 2 for nitrogen gas is 66.63 cm³/g. The specific surface areas calculated by HK method and langmuir method with this absorption site (or the value of the absorption site) are 224 m²/g and 274 m²/g. By observing the absorption/desorption curve of compound 2 for nitrogen gas, it is recognized that the pores morphology of compound 2 is Type I micropores morphology. After the result of the absorption/desorption of compound 2 for nitrogen gas is calculated by HK method, it is recognized that the pore size of compound 2 is 8.4×8.5 Å² and 12.4×12.5 Å², as FIG. 8D shows. Also, the absorption/desorption curve of compound 2 for nitrogen gas can prove that the compound 2 is a porous material (metal-organic framework; MOF).

Referring to FIG. 8B, it shows the absorption isotherm of compound 2 for hydrogen gas, in which the absorption for hydrogen gas is the y axis and the p/pₒ is the x axis. When at 77 K, degassing for 36 hours, and p/pₒ=1, the absorption of compound 2 for hydrogen gas is 0.70 wt %. Referring to FIG. 8C, it shows the absorption isotherm of compound 2 for carbon dioxide gas, in which the absorption for carbon dioxide gas is the y axis and the p/pₒ is the x axis. When at 293 K, degassing for 36 hours, and pressure/torr=760, the absorption of compound 2 for carbon dioxide gas is 1.48 mmol/g.

The result of the absorption/desorption of compound 3 for nitrogen gas, hydrogen gas, and carbon dioxide gas, and pore size analysis of compound 2 with HK method by a ASAP-2020 BET are respectively shown in FIG. 8E to FIG. 8H. The operation and condition for the test of absorption/desorption of compound 3 is the same with that of compound 2. Referring to FIG. 8E, it shows the absorption isotherm of compound 3 for nitrogen gas, in which the absorption for nitrogen gas is the y axis and the p/pₒ is the x axis. When at 77 K, degassing for 36 hours, and p/pₒ=1, the absorption of compound 3 for nitrogen gas is 24.65 cm³/g. The specific surface areas calculated by HK method and langmuir method with this absorption site (or the value of the absorption site) are 79 m²/g and 96 m²/g. By observing the absorption/desorption curve of compound 3 for nitrogen gas, it is recognized that the pores morphology of compound 3 is Type I micropores morphology. After the result of the absorption/desorption of compound 3 for nitrogen gas is calculated by HK method, it is recognized that the pore size of compound 3 is 8.7×8.6 Å², as FIG. 8H shows. Also, the absorption/desorption curve of compound 3 for nitrogen gas can prove that the compound 3 is a porous material (metal-organic framework; MOF).

Referring to FIG. 8F, it shows the absorption isotherm of compound 3 for hydrogen gas, in which the absorption for hydrogen gas is the y axis and the p/pₒ is the x axis. When at 77 K, degassing for 36 hours, and p/pₒ=1, the absorption of compound 3 for hydrogen gas is 0.25 wt %. Referring to FIG. 8G, it shows the absorption isotherm of compound 3 for carbon dioxide gas, in which the absorption for carbon dioxide gas is the y axis and the p/pₒ is the x axis. When at 293 K, degassing for 36 hours, and pressure/torr=760, the absorption of compound 3 for carbon dioxide gas is 1.17 mmol/g.

Compound 2 can be synthesized by hydrothermal method or microwave syntheses method. The hydrothermal method for synthesizing compound 2 is detailed as following: First, 0.0945 g (0.4 mmol) Ca(NO₃)₂.4H₂O, 0.0612 g (0.2 mmol) 4,4′-sulfonyldibenzoic acid (H₂SBA), 9.0 mL ethanol (EtOH), and 1.0 mL water (H₂O) are put into the Teflon inner cup in order. And then, the Teflon inner cup is put into the iron outer cup and the reactor is put into the high temperature furnace. In the high temperature furnace, the reactor (or the Ca(NO₃)₂.4H₂O, 4,4′-sulfonyldibenzoic acid (H₂SBA), ethanol (EtOH), and water (H₂O) in the reactor) is heated to 120° C. with 60°Ch⁻¹ and it is maintained at 120° C. for reacting for about 2 days. After, the reactor is cooled to room temperature with 6° Ch⁻¹. And then, compound 2 is gotten through suction filtration, washing with ethanol and water, and drying. The compound 2 is a transparent tabular crystal. The weight of the gotten compound 2 is 0.0323 g, and the yield of the compound 2 is 44.5% by calculating with defining the 4,4′-sulfonyldibenzoic acid (H₂SBA) as a limiting reagent. The microwave syntheses method for synthesizing compound 2 is detailed as following: First, Ca(NO₃)₂.4H₂O, 4,4′-sulfonyldibenzoic acid (H2SBA), ethanol (EtOH), and water (H₂O) with the same weight (or weight ratio) as above mentioned are put into the Teflon inner cup in order. And then, the Teflon inner cup is put into the iron outer cup and the reactor is put into the microwave reactor. In the microwave reactor, the output power of the microwave reactor is set to 400 W, and the reactor (or the Ca(NO₃)₂.4H₂O, 4,4′-sulfonyldibenzoic acid (H₂SBA), ethanol (EtOH), and water (H₂O) in the reactor) is heated to 150° C. with 60° Ch⁻¹. It is maintained at 150° C. for reacting or synthesizing for 20 minutes. After, the reactor is cooled to room temperature with 6° Ch⁻¹. And then, compound 2 is gotten through suction filtration, washing with ethanol and water, and drying. A compound is produced by heating compound 2 to 200° C. to remove water of crystallization from compound 2. According to powder X-ray diffraction analysis for this compound, it is found that the structures of this compound and compound 2 are almost the same and this compound has a formula [Ca(SBA)]. The weight of the Ca(NO₃)₂.4H₂O, 4,4′-sulfonyldibenzoic acid (H₂SBA), ethanol (EtOH), and water (H₂O) mentioned above are just taken as an example, and not limited to this. The weight of the Ca(NO₃)₂.4H₂O, 4,4′-sulfonyldibenzoic acid (H₂SBA), ethanol (EtOH), and water (H₂O) could be increased or decreased with the same ratio of weight mentioned above.

Compound 3 also can be synthesized by hydrothermal method or microwave syntheses method. The hydrothermal method for synthesizing compound 3 is detailed as following: First, 0.1692 g (0.8 mmol) Sr(NO₃)₂, 0.0612 g (0.2 mmol) 4,4′-sulfonyldibenzoic acid (H₂SBA), 7.0 mL ethanol (EtOH), and 3.0 mL water (H₂O) are put into the Teflon inner cup in order. And then, the Teflon inner cup is put into the iron outer cup and the reactor is put into the high temperature furnace. In the high temperature furnace, the reactor (or the Sr(NO₃)₂, 4,4′-sulfonyldibenzoic acid (H₂SBA), ethanol (EtOH), and water (H₂O) in the reactor) is heated to 150° C. with 60° Ch⁻¹ and it is maintained at 150° C. for reacting for about 2 days. After, the reactor is cooled to room temperature with 6° Ch⁻¹. And then, compound 3 is gotten through suction filtration, washing with ethanol and water, and drying. The compound 3 is a transparent fringe crystal (or columnar crystal). The weight of the gotten compound 3 is 0.0616 g, and the yield of the compound 3 is 75.3% by calculating with defining the 4,4′-sulfonyldibenzoic acid (H₂SBA) as a limiting reagent. The microwave syntheses method for synthesizing compound 3 is detailed as following: First, Sr(NO₃)₂, 4,4′-sulfonyldibenzoic acid (H₂SBA), ethanol (EtOH), and water (H₂O) with the same weight (or weight ratio) as above mentioned are put into the Teflon inner cup in order. And then, the Teflon inner cup is put into the iron outer cup and the reactor is put into the microwave reactor. In the microwave reactor, the output power of the microwave reactor is set to 400 W, and the reactor (or the Sr(NO₃)₂, 4,4′-sulfonyldibenzoic acid (H₂SBA), ethanol (EtOH), and water (H₂O) in the reactor) is heated to 180° C. with 60° Ch⁻¹. It is maintained at 180° C. for reacting or synthesizing for 20 minutes. After, the reactor is cooled to room temperature with 6° Ch⁻¹. And then, compound 3 is gotten through suction filtration, washing with ethanol and water, and drying. A compound is produced by heating compound 3 to 200° C. to remove water of crystallization from compound 3. According to powder X-ray diffraction analysis for this compound, it is found that the structures of this compound and compound 3 are almost the same and this compound has a formula [Sr(SBA)]. The weight of the Sr(NO₃)₂, 4,4′-sulfonyldibenzoic acid (H₂SBA), ethanol (EtOH), and water (H₂O) mentioned above are just taken as an example, and not limited to this. The weight of the Sr(NO₃)₂, 4,4′-sulfonyldibenzoic acid (H₂SBA), ethanol (EtOH), and water (H₂O) could be increased or decreased with the same ratio of weight mentioned above.

### Third Embodiment

Compound 4 has a formula [Mn(SBA)(EtOH)]. Compound 4 is a 2D layered metal-organic framework (MOF) composed of divalent Manganese (Mn) ions and 4,4′-sulfonyldibenzoic acid groups (SBA), in which Manganese (Mn) ion is used to be central metal and SBA is used to be organic ligand. The result of single-crystal X-ray diffraction analysis shows that compound 4 is monoclinic and the space group of compound 4 is P2/n.

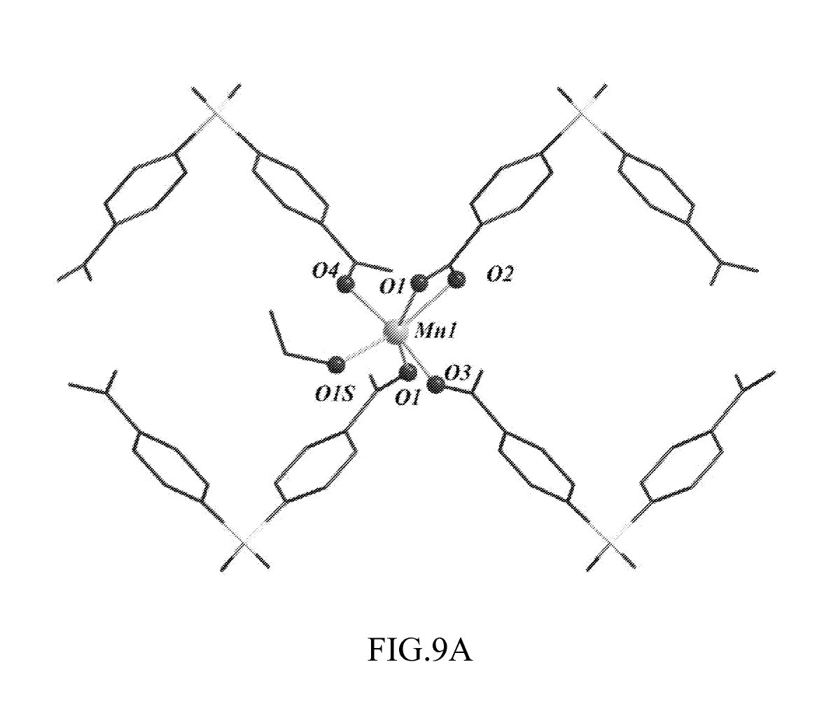

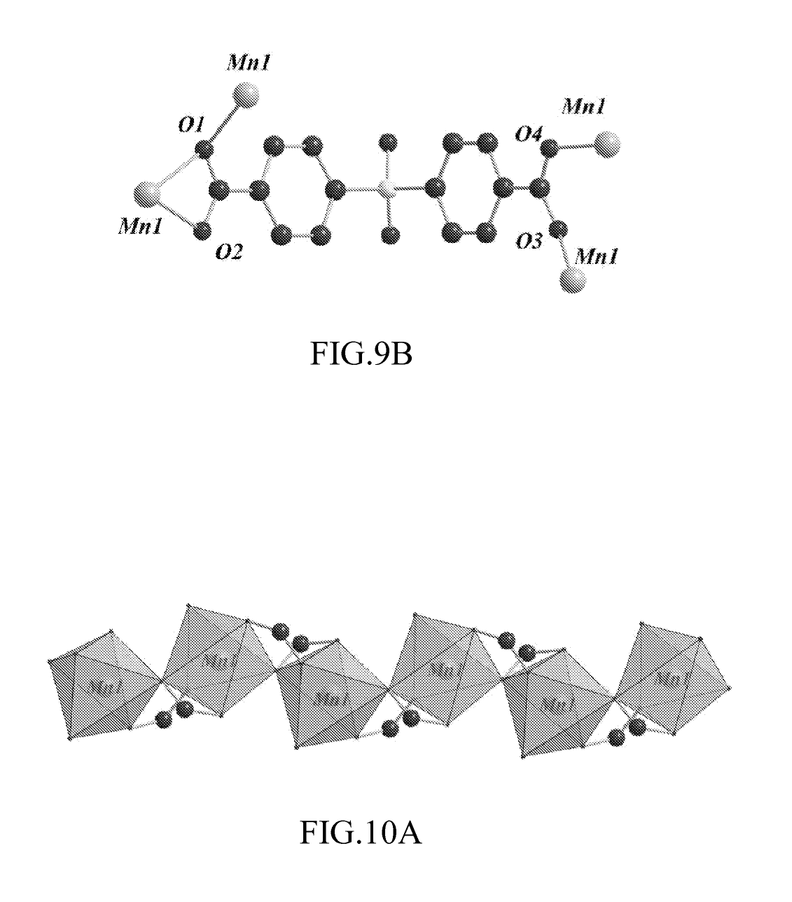

FIG. 9A shows one asymmetric unit of compound 4, which is coordination environment of Mn ion. Compound 4 is composed of a plurality of asymmetric units shown in FIG. 9A. Referring to FIG. 9A, the asymmetric unit comprises one Mn ion Mn(1) to be the metal center of the asymmetric unit. The Mg ion Mg(1) is six-coordinated and the Mg ion Mg(1) is coordinated with six oxygen atoms (O). Five of the six oxygen atoms are the oxygen atoms of the carboxyl groups (—COON) of four SBA ligands, and the remaining one of the six oxygen atoms are the oxygen atoms of one water molecules (H₂O). The Mn—O bond lengths in the asymmetric unit are shown in Table 4.

TABLE 4

| | | | |
|---|---|---|---|
| Mn(1)-O(3) | 2.085(3) | Mn(1)-O(1)#1 | 2.178(2) |
| Mn(1)-O(4)#1 | 2.109(3) | Mn(1)-O(2) | 2.239(3) |
| Mn(1)-O(1S) | 2.166(3) | Mn(1)-O(1) | 2.369(3) |

Symmetry transformations used to generate equivalent atoms:
#1 −x + 3/2, y − 1/2, −z + 1/2

FIG. 9B shows the coordination environment of one 4,4′-sulfonyldibenzoic acid ligand (SBA) in compound 4. According to FIG. 9B, coordination environment of each 4,4′-sulfonyldibenzoic acid ligand (SBA) is μ₄-bridge ligand. Each of 4,4′-sulfonyldibenzoic acid ligands (SBA) has four oxygen atoms (O) coordinated with four Mn ions respectively.

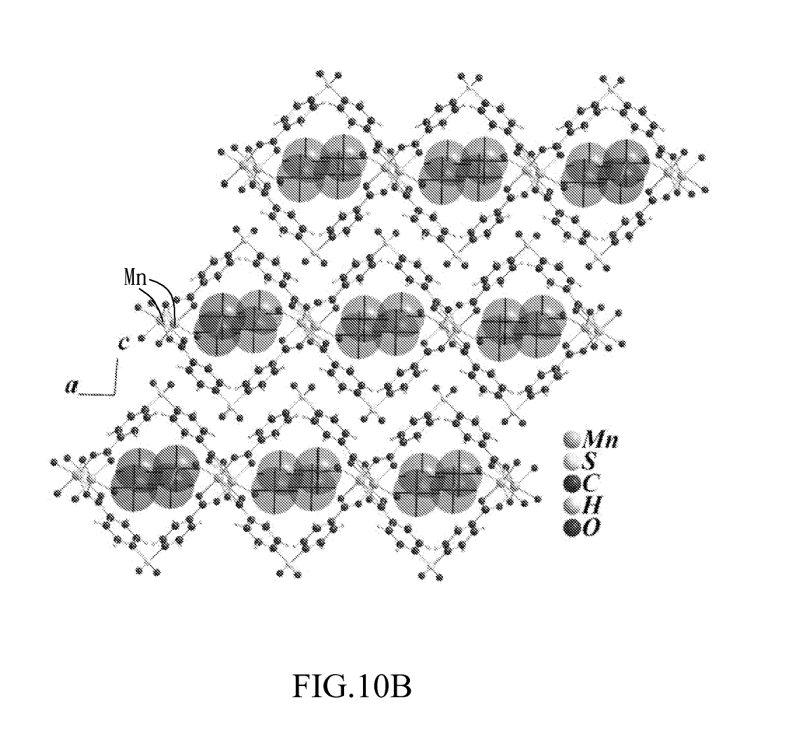

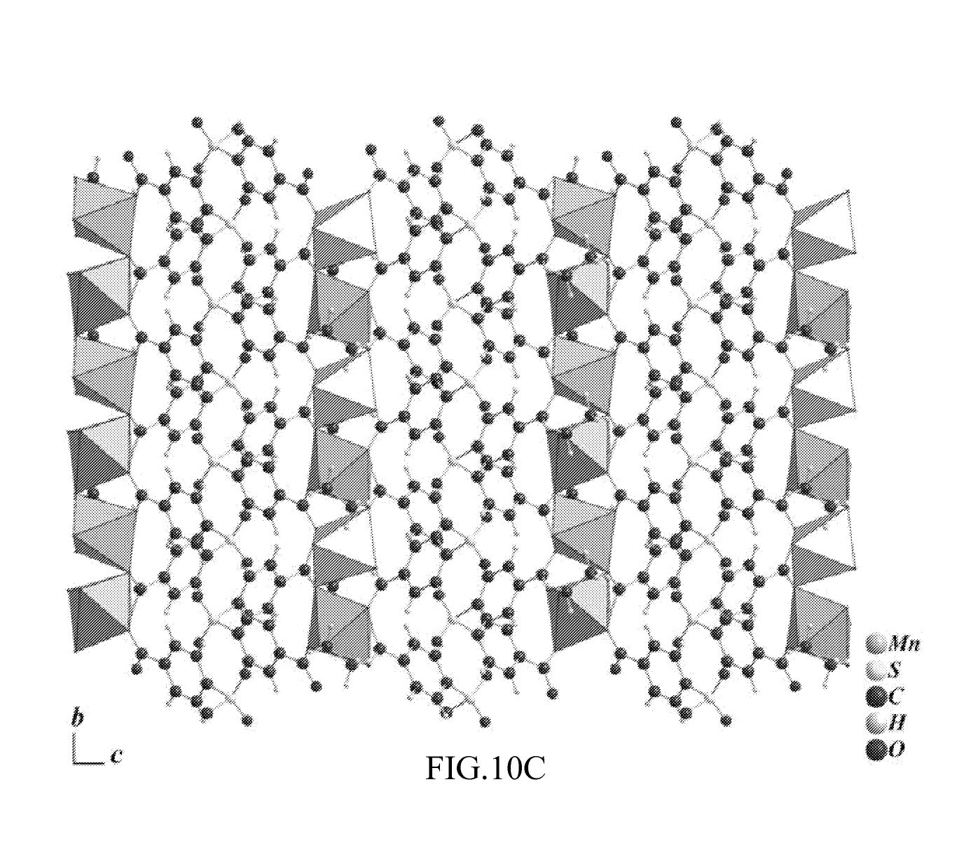

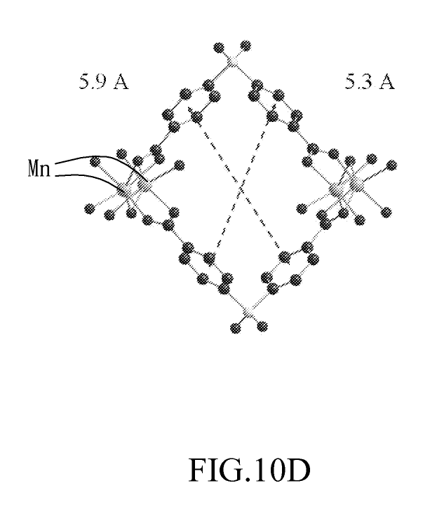

Compound 4 is a 2D layered metal-organic framework (MOF). In Compound 4, [MnO₆]octahedron is accomplished by central metal Mn and oxygen atoms, and a 1D inorganic chain is formed by sharing points and edges of [MnO₆]octahedron with each other as FIG. 10A shows. This 1D inorganic chain is bonded to the O—C—O groups of the SBA to form a 2D layered structure as FIG. 10B shows. FIG. 10B shows the 2D structure in view in [010] direction, and the circle patterns in the pores are solvent molecules. FIG. 100 shows the 2D structure of compound 4 in which the solvent molecules are removed. FIG. 10D shows the pores produced in compound 4. The cross-section area of the 1D channel along b axis is 5.3×5.9 Å² (utilizing the length of the connecting line between two center points of two benzene rings). The van der waals radius of atoms have been omitted in the cross-section area figured herein. The pore size, which is figured out by PLATON method after removing of solvent, is 74.2 Å³, and the volume of the pores occupies 22.6% crystal volume of the compound 4.

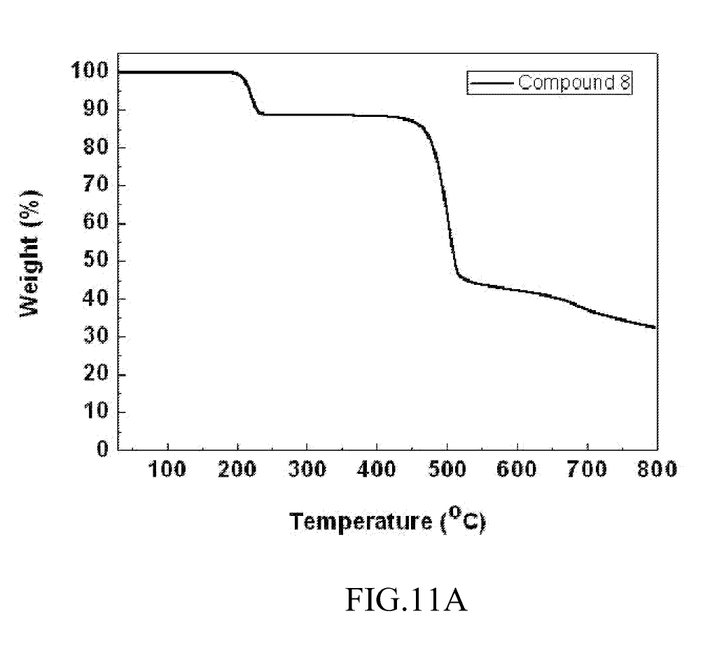

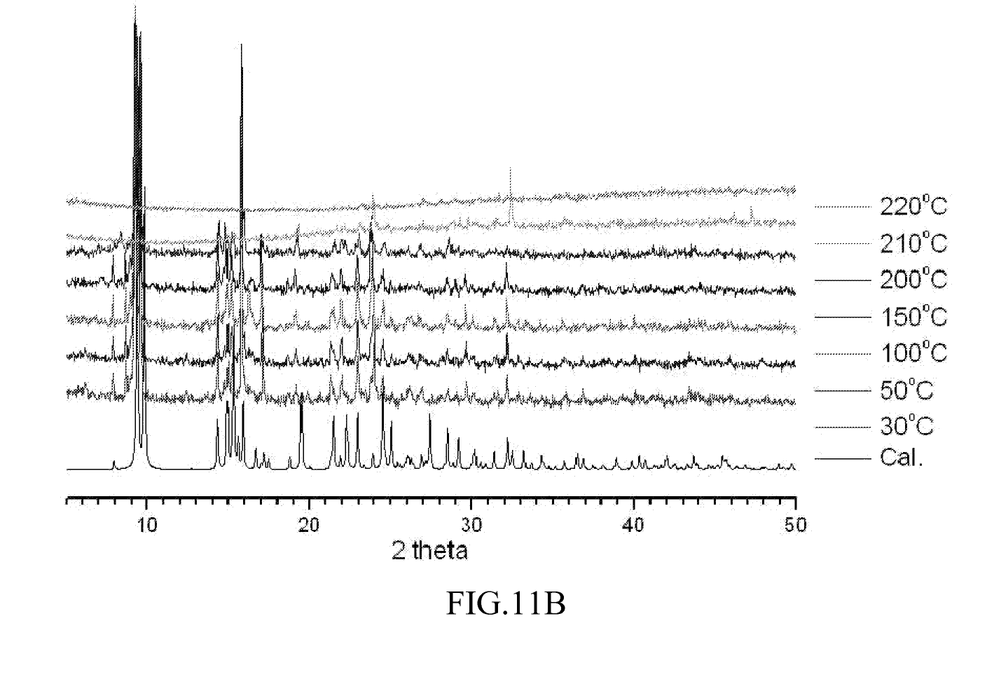

The result- of thermogravimetric analysis for compound 4 by thermogravimetric analyzer (TAG) is shown in FIG. 11A. Referring to FIG. 11A, by observing the weight loss curve, it is found that the first heat loss of compound 4 is occurred at 180° C-240° C. and about 11.1% weight of compound 4 is lost at 80° C-240° C. Therefore, it is recognized that one coordinated ethanol is removed in this stage (Cal. EtOH, 11.3%). After, there is on any heat loss of compound 4 until 400° C. At 800° C., the structure of compound 4 begins to decompose (Cal. SBA, 75.7%).

The result of powder X-ray diffraction analysis for compound 4 by a SHIMADZU XRD-6000 automated powder diffractometer is shown in FIG. 11B. Referring to FIG. 11B, by observing the powder X-ray, it is found that the ethanol of crystallization in compound 4 is removed at 200° C.

Compound 4 also can be synthesized by hydrothermal method or microwave syntheses method. The hydrothermal method for synthesizing compound 4 is detailed as following: First, 0.100 g (0.4 mmol) Mn(NO₃)₂.4H₂O, 0.1224g (0.4 mmol) 4,4′-sulfonyldibenzoic acid (H₂SBA), 5.0 mL ethanol (EtOH), and 1.0 mL water (H₂O) are put into the Teflon inner cup in order. And then, the Teflon inner cup is put into the iron outer cup and the reactor is put into the high temperature furnace. In the high temperature furnace, the reactor (or the Mn(NO₃)₂.4H₂O, 4,4′-sulfonyldibenzoic acid (H₂SBA), ethanol (EtOH), and water (H₂O) in the reactor) is heated to 150° C. with 60° Ch⁻¹ and it is maintained at 150° C. for reacting for about 2 days. After, the reactor is cooled to room temperature with 6° Ch⁻¹. And then, compound 4 is gotten through suction filtration, washing with ethanol and water, and drying. The compound 4 is a transparent acicular crystal. The weight of the gotten compound 4 is 0.0705 g, and the yield of the compound 4 is 87.2% by calculating with defining the 4,4′-sulfonyldibenzoic acid (H₂SBA) as a limiting reagent. The weight of the Mn(NO₃)₂.4H₂O, 4,4′-sulfonyldibenzoic acid (H₂SBA), ethanol (EtOH), and water (H₂O) mentioned above are just taken as an example, and not limited to this. The weight of the Mn(NO₃)₂.4H₂O, 4,4′-sulfonyldibenzoic acid (H₂SBA), ethanol (EtOH), and water (H₂O) could be increased or decreased with the same ratio of weight mentioned above.

The microwave syntheses method for synthesizing compound 4 is detailed as following: First, Mn(NO₃)₂.4H₂O, 4,4′-sulfonyldibenzoic acid (H₂SBA), ethanol (EtOH), and water (H₂O) with the same weight (or weight ratio) as above mentioned are put into the Teflon inner cup in order. And then, the Teflon inner cup is put into the iron outer cup and the reactor is put into the microwave reactor. In the microwave reactor, the output power of the microwave reactor is set to 400 W, and the reactor (or the Mn(NO₃)₂.4H₂O, 4,4′-sulfonyldibenzoic acid (H₂SBA), ethanol (EtOH), and water (H₂O) in the reactor) is heated to 180° C. with 60° Ch⁻¹. It is maintained at 180° C. for reacting for 20 minutes. After, the reactor is cooled to room temperature with 6° Ch⁻¹. And then, compound 4 is gotten through suction filtration, washing with ethanol and water, and drying. The weight of the Mn(NO₃)₂.4H₂O, 4,4′-sulfonyldibenzoic acid (H₂SBA), ethanol (EtOH), and water (H₂O) mentioned above are just taken as an example, and not limited to this. The weight of the Mn(NO₃)₂.4H₂O, 4,4′-sulfonyldibenzoic acid (H₂SBA), ethanol (EtOH), and water (H₂O) could be increased or decreased with the same ratio of weight mentioned above.

### Fourth Embodiment

Compound 5 has a formula [Zn₃(SBA)₂(OH)₂].EtOH. Compound 5 is a 2D layered metal-organic framework (MOF) composed of divalent Zinc (Zn) ions and 4,4′-sulfonyldibenzoic acid groups (SBA), in which Zinc (Zn) ion is used to be central metal and SBA is used to be organic ligand. The result of single-crystal X-ray diffraction analysis shows that compound 5 is monoclinic and the space group of compound 1 is P2/n.

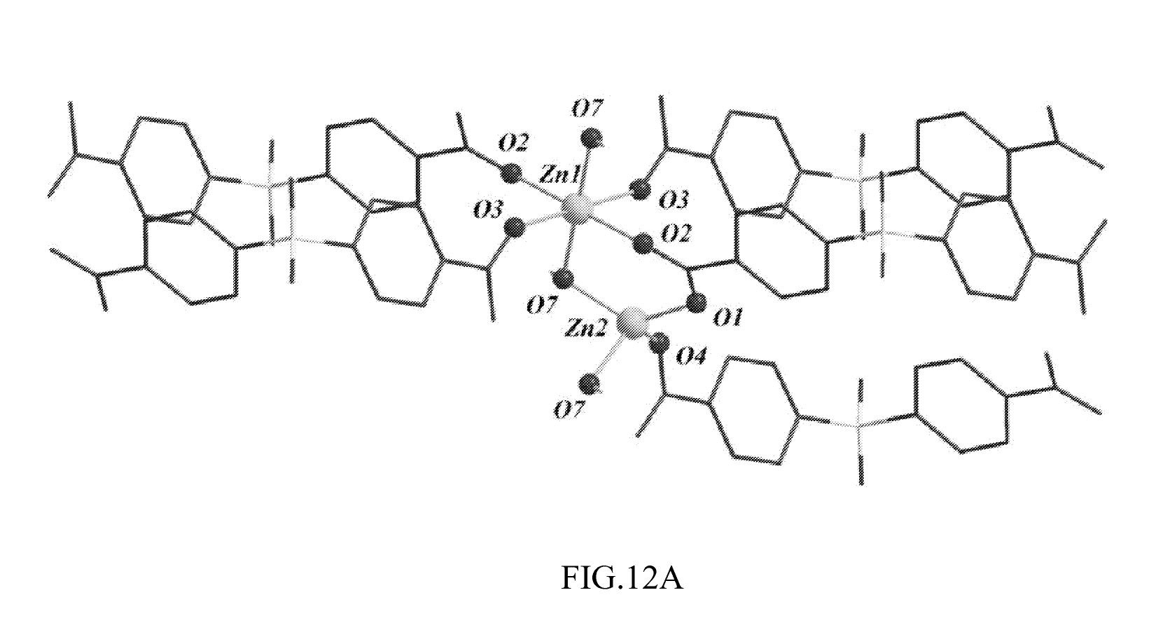

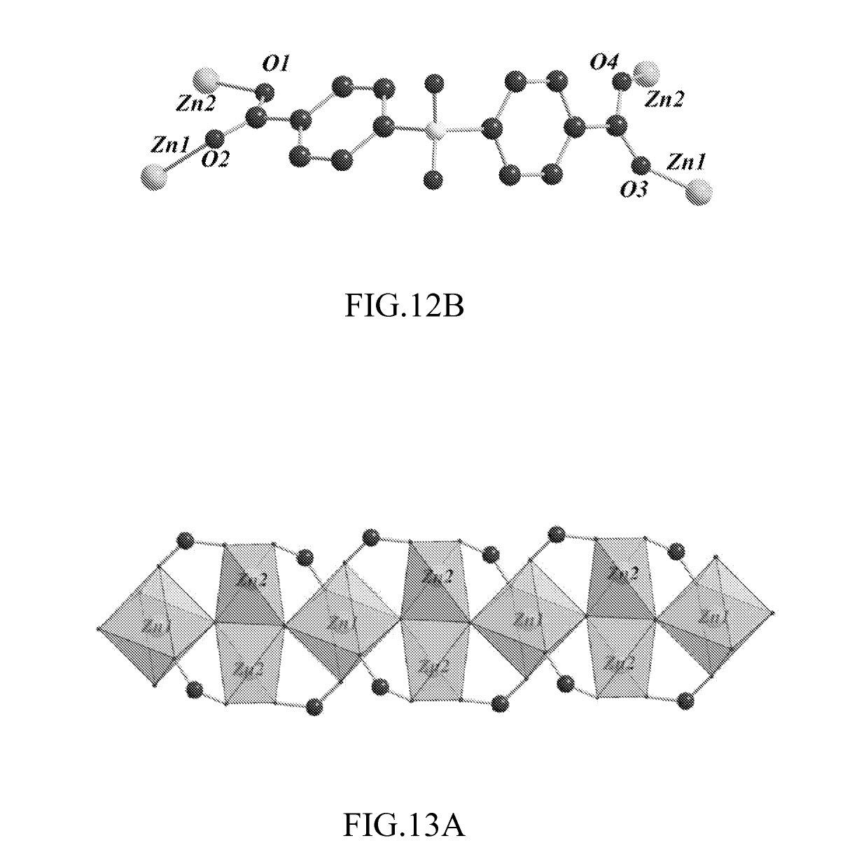

FIG. 12A shows one asymmetric unit of compound 5, which is coordination environment of Zn ion. Compound 5 is composed of a plurality of asymmetric units shown in FIG. 12A. Referring to FIG. 12A, the asymmetric unit comprises two Zn ions Zn(1) and Zn(2) to be the metal centers of the asymmetric unit. The Zn ion Zn(1) is six-coordinated and the Zn ion Zn(1) is coordinated with six oxygen atoms (O). Four of the six oxygen atoms are the oxygen atoms of the carboxyl groups (—COOH) of four SBA ligands, and the remaining two of the six oxygen atoms are the oxygen atoms of two hydroxyl groups (—OH). The Zn ion Zn(2) is four-coordinated and the Zn ion Zn(2) is coordinated with four oxygen atoms (O). Two of the six oxygen atoms are the oxygen atoms of the carboxyl groups (—COOH) of two SBA ligands, and the remaining two of the six oxygen atoms are the oxygen atoms of two hydroxyl groups (—OH). The Zn—O bond lengths in the asymmetric unit are shown in Table 5.

TABLE 5

| | | | |
|---|---|---|---|
| Zn(1)-O(7)#1 | 2.027(3) | Zn(1)-O(2)#1 | 2.080(3) |
| Zn(1)-O(7) | 2.027(3) | Zn(1)-O(3) | 2.170(3) |
| Zn(1)-O(2) | 2.080(3) | Zn(1)-O(3)#1 | 2.170(3) |
| Zn(2)-O(4) | 1.909(3) | Zn(2)-O(7) | 1.965(3) |
| Zn(2)-O(1) | 1.927(3) | Zn(2)-O(7)#2 | 2.003(3) |

Symmetry transformations used to generate equivalent atoms:
#1 −x + 1, −y + 1, −z + 1
#2 −x + 1, −y + 2, −z + 1

FIG. 12B shows the coordination environment of one 4,4′-sulfonyldibenzoic acid ligand (SBA) in compound 5. According to FIG. 12B, coordination environment of each 4,4′-sulfonyldibenzoic acid ligand (SBA) is μ₄-bridge ligand. Each of 4,4′-sulfonyldibenzoic acid ligands (SBA) has four oxygen atoms (O) coordinated with four Zn ion respectively.

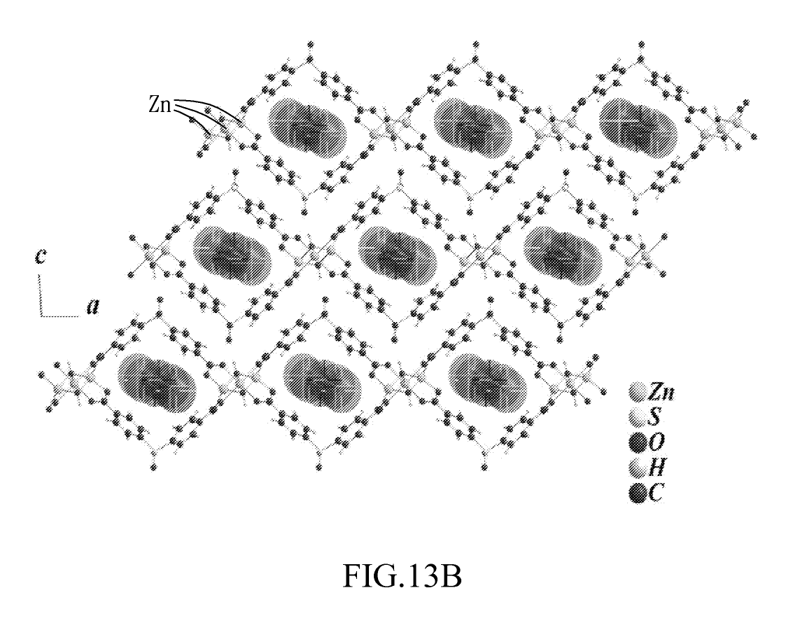

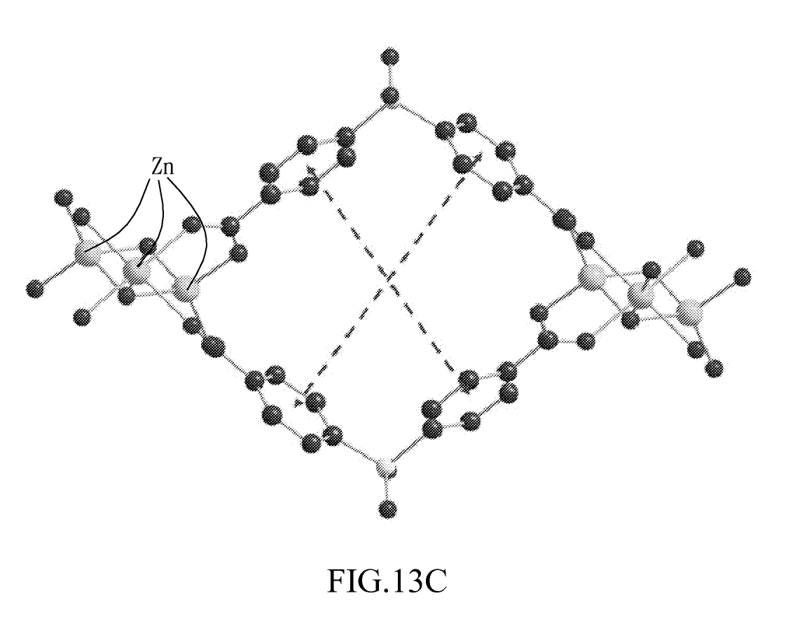

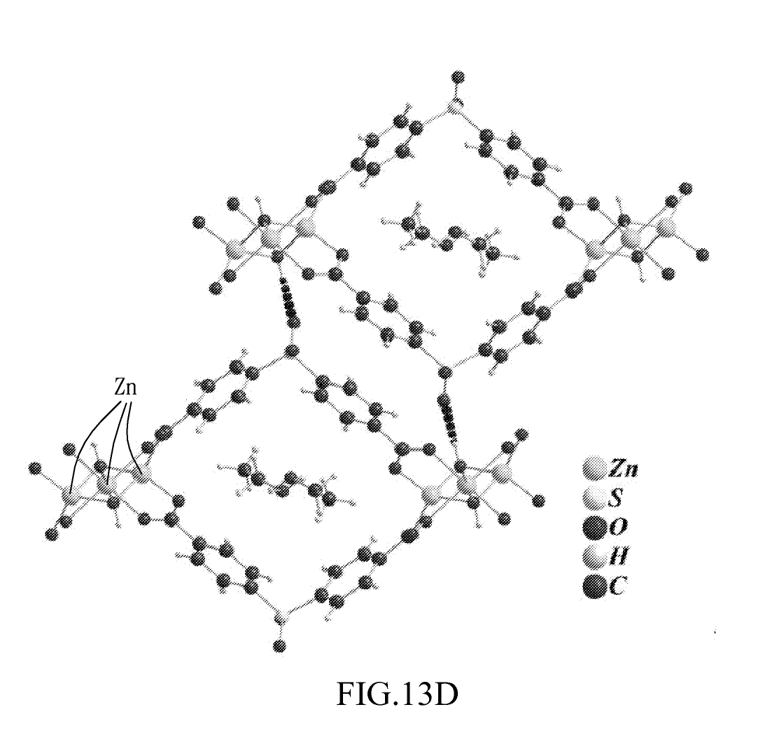

Compound 5 is a 2D layered metal-organic framework (MOF). In Compound 5, [ZnO₆]octahedron is accomplished by central metal Zn and oxygen atoms, and a 1D inorganic chain is formed by sharing points and edges of [ZnO₆]octahedron with each other as FIG. 13A shows. This 1D inorganic chain is bonded to the O—C—O groups of the SBA to form a 2D layered structure as FIG. 13B shows. FIG. 13B shows the 2D structure in view in [010] direction, and the circle patterns in the pores are solvent molecules. The 2D layered structures are bonded with each other by hydrogen bonds, which is caused by the hydrogen atoms of the coordinated water, to form a 3D network structure as FIG. 13D shows. In FIG. 13D, the dotted lines represent the hydrogen bonds. FIG. 13C shows the pores produced in compound 5. The cross-section area of the 1D channel along b axis is 5.6×5.5 Å² (utilizing the length of the connecting line between two center points of two benzene rings). The van der waals radius of atoms have been omitted in the cross-section area figured herein. The pore size, which is figured out by PLATON method after removing of solvent, is 301.7 Å³, and the volume of the pores occupies 18.5% crystal volume of the compound 5.

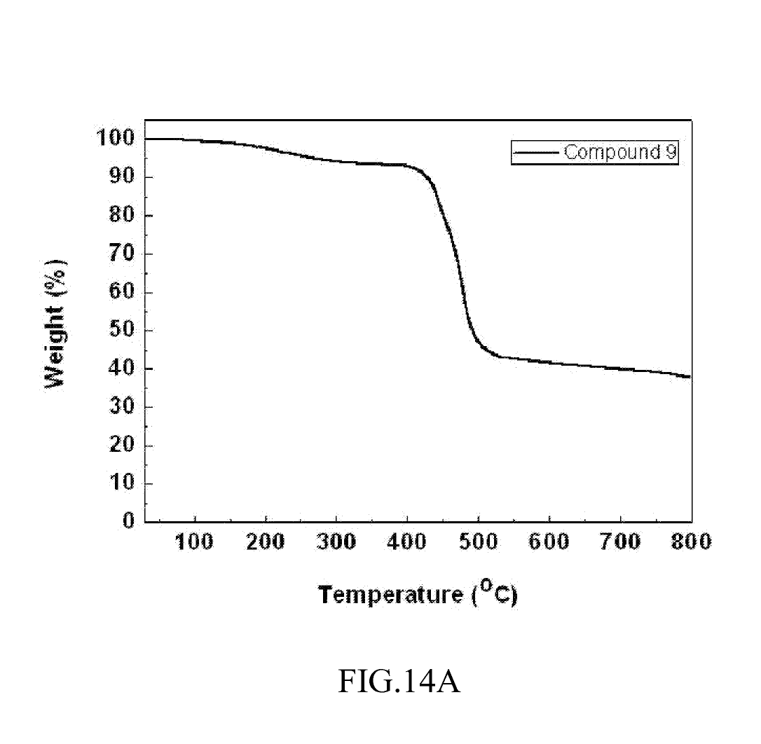

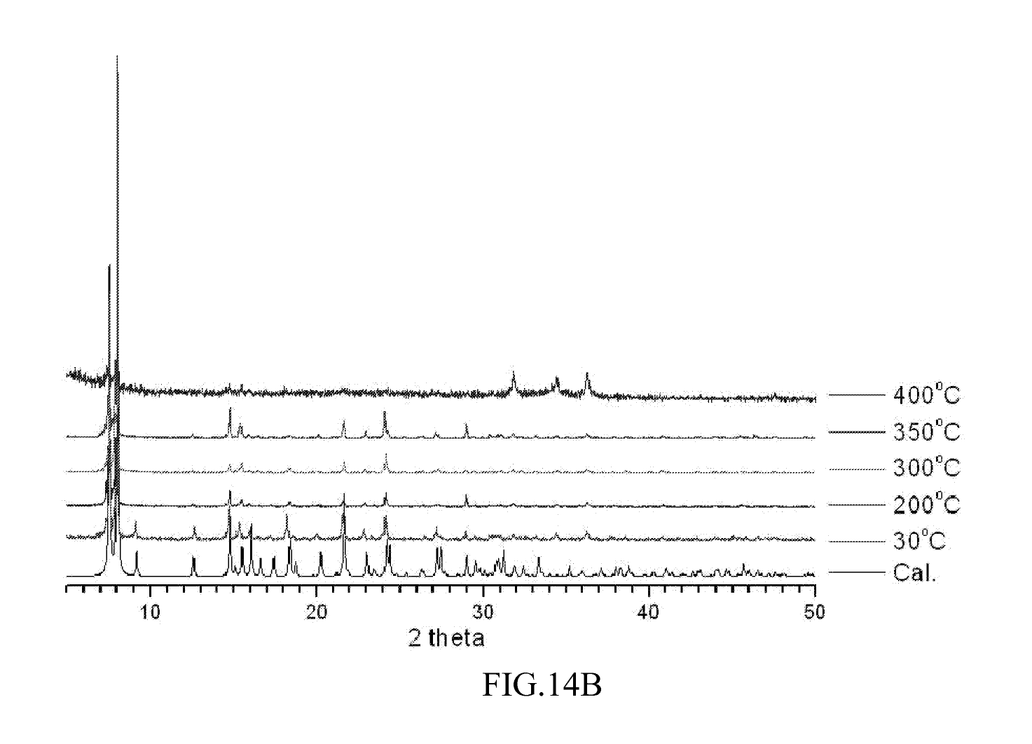

The result of thermogravimetric analysis for compound 5 by thermogravimetric analyzer (TAG) is shown in FIG. 14A. Referring to FIG. 14A, by observing the weight loss curve, it is found that the first heat loss of compound 5 is occurred at 130° C-300° C. and about 6.1% weight of compound 5 is lost at 130° C-300° C. Therefore, it is recognized that one ethanol of crystallization is removed in this stage (Cal. EtOH, 5.2%). After, there is on any heat loss of compound 5 until 350° C. At 800° C., the structure of compound 5 begins to decompose (Cal. SBA, 69.1%).

The result of powder X-ray diffraction analysis for compound 5 by a SHIMADZU XRD-6000 automated powder diffractometer is shown in FIG. 14B. Referring to FIG. 14B, by observing the powder X-ray, it is found that one ethanol of crystallization in compound 5 is removed at 300° C. By powder X-ray diffraction analysis for this compound in which one ethanol of crystallization is removed at 300° C., it is recognized that this compound has a formula [Zn₃(SBA)₂(OH)₂]. Finally, compound 5 begins to decompose at 400° C.

Compound 5 also can be synthesized by hydrothermal method or microwave syntheses method. The hydrothermal method for synthesizing compound 5 is detailed as following: First, 0.118 g (0.4 mmol) Zn(NO₃)₂.6H₂O, 0.0612 g (0.2 mmol) 4,4′-sulfonyldibenzoic acid (H₂SBA), 5.0 mL ethanol (EtOH), and 1.0 mL water (H₂O) are put into the Teflon inner cup in order. And then, the Teflon inner cup is put into the iron outer cup and the reactor is put into the high temperature furnace. In the high temperature furnace, the reactor (or the Zn(NO₃)₂.6H₂O, 4,4′-sulfonyldibenzoic acid (H₂SBA), ethanol (EtOH), and water (H₂O) in the reactor) is heated to 150° C. with 60° Ch⁻¹ and it is maintained at 150° C. for reacting for about 2 days. After, the reactor is cooled to room temperature with 6° Ch⁻¹. And then, compound 5 is gotten through suction filtration, washing with ethanol and water, and drying. The compound 5 is a transparent acicular crystal. The weight of the gotten compound 5 is 0.0782 g, and the yield of the compound 5 is 88.4% by calculating with defining the 4,4′-sulfonyldibenzoic acid (H₂SBA) as a limiting reagent. The weight of the Zn(NO₃)₂.6H₂O, 4,4′-sulfonyldibenzoic acid (H₂SBA), ethanol (EtOH), and water (H₂O) mentioned above are just taken as an example, and not limited to this. The weight of the Zn(NO₃)₂.6H₂O, 4,4′-sulfonyldibenzoic acid (H₂SBA), ethanol (EtOH), and water (H₂O) could be increased or decreased with the same ratio of weight mentioned above.

The microwave syntheses method for synthesizing compound 5 is detailed as following: First, 0.236 g (0.8 mmol) Zn(NO₃)₂.6H₂O, 0.1224 g (0.4 mmol) 4,4′-sulfonyldibenzoic acid (H₂SBA), 9.0 mL ethanol (EtOH), and 1.0 mL water (H₂O) are put into the Teflon inner cup in order. And then, the Teflon inner cup is put into the iron outer cup and the reactor is put into the microwave reactor. In the microwave reactor, the output power of the microwave reactor is set to 400 W, and the reactor (or the Zn(NO₃)₂.6H₂O, 4,4′-sulfonyldibenzoic acid (H₂SBA), ethanol (EtOH), and water (H₂O) in the reactor) is heated to 180° C. with 60° Ch⁻¹. It is maintained at 180° C. for reacting for 40 minutes. After, the reactor is cooled to room temperature with 6° Ch⁻¹. And then, compound 5 is gotten through suction filtration, washing with ethanol and water, and drying. The weight of the Zn(NO₃)₂.6H₂O, 4,4¹-sulfonyldibenzoic acid (H₂SBA), ethanol (EtOH), and water (H₂O) mentioned above are just taken as an example, and not limited to this. The weight of the Zn(NO₃)₂.6H₂O, 4,4′-sulfonyldibenzoic acid (H₂SBA), ethanol (EtOH), and water (H₂O) could be increased or decreased with the same ratio of weight mentioned above.

According to the above-mentioned first and second embodiments, this invention provides three novel organic-inorganic metal (II) coordination polymers (or MOFs): compound 1 [Mg₃(OH)₂(SBA)₂(EtOH)(H₂O)₃].3.5H₂O, compound 2 [Ca(SBA)].(H₂O) and compound 3 [Sr(SBA)].0.5(H₂O). In the embodiments, the environmentally friendly, non-toxic and cheap alkaline-earth metals of magnesium (Mg), Calcium (Ca) and Strontium (Sr) and 4,4′-sulfonyldibenzoic acids (H₂SBA) are used to synthesize these three novel organic-inorganic metal (II) coordination polymers. These three novel organic-inorganic metal coordination polymers have good absorption/desorption for hydrogen gas and carbon dioxide gas. The absorption/desorption of compounds 1-3 for carbon dioxide gas are 1.71 mmol/g, 1.48 mmol/g, and 1.11 mmol/g respectively. Comparing with common MOFs, such as absorption/desorption of MOF5 for carbon dioxide gas is 1.71 mmol/g at 298 K and 1 atm and absorption/desorption of ZIP-8 for carbon dioxide gas is 0.96 mmol/g at 298 K and 1 atm, the absorption/desorption of compounds 1-3 for carbon dioxide gas are almost equal to or greater than the absorption/desorption of MOF5 and ZIP-8 for carbon dioxide gas. Furthermore, the absorption/desorption of compounds 1-3 for carbon dioxide gas are greater than that of the common MOFs, such as ZIP-100 and ZIP-8. The absorption/desorption of compounds 1-3 for nitrogen gas are 0.32 wt %, 0.7 wt %, and 0.7 wt % respectively. They are not much greater than the common MOFs, but it is recognized that compounds 1-3 have good absorption/desorption for nitrogen gas.

According to the above-mentioned third and fourth embodiments, this invention provides two novel organic-inorganic metal (II) coordination polymers (or MOFs): compound 4 [Mn(SBA)(EtOH)] and compound 5 [Zn₃(SBA)₂(OH)₂].EtOH. In the embodiments, the transitional metals of Manganese (Mn) and Zinc (Zn) and 4,4′-sulfonyldibenzoic acids (H₂SBA) are used to synthesize these two novel organic-inorganic metal (II) coordination polymers. In compounds 4 and 5, Manganese (Mn) and Zinc (Zn) are used to be metal center and 4,4′-sulfonyldibenzoic acids (H₂SBA) are used to be the ligands.

Although specific embodiments have been illustrated and described, it will be appreciated by those skilled in the art that various modifications may be made without departing from the scope of the present invention, which is intended to be limited solely by the appended claims.

What is claimed is:

1. A metal (II) coordination polymer, comprising:
one or several metal (II) used to be central metal ions; and
a plurality of 4,4′-sulfonyldibenzoic acids (H₂SBA) used to be organic ligands.

2. The metal (II) coordination polymer of claim 1, wherein said metal (II) is Magnesium (Mg).

3. The metal (II) coordination polymer of claim 2, wherein said metal (II) coordination polymer has a formula [Mg₃(OH)₂(SBA)₂(EtOH)(H₂O)₃]3.5H₂O.

4. The metal (II) coordination polymer of claim 3, wherein each asymmetric unit of said metal (II) coordination polymer contains three magnesium (Mg) ions.

5. The metal (II) coordination polymer of claim 4, wherein each magnesium (Mg) ion in said asymmetric unit is six-coordinated and each magnesium (Mg) ion in said asymmetric unit is coordinated with six oxygen atoms.

6. The metal (II) coordination polymer of claim 5, wherein coordination environment of each said 4,4′-sulfonyldibenzoic acids (H₂SBA) is μ₄-bridge ligand.

7. The metal (II) coordination polymer of claim 6, wherein said metal (II) coordination polymer is 2D layered metal-organic framework (MOF).

8. The metal (II) coordination polymer of claim 1, wherein said metal (II) is Calcium (Ca).

9. The metal (II) coordination polymer of claim 8, wherein said metal (II) coordination polymer has a formula [Ca(SBA)].(H₂O).

10. The metal (II) coordination polymer of claim 9, wherein each asymmetric unit of said metal (II) coordination polymer contains one Calcium (Ca) ion.

11. The metal (II) coordination polymer of claim 10, wherein each Calcium (Ca) ion in said asymmetric unit is seven-coordinated and each Calcium (Ca) ion in said asymmetric unit is coordinated with seven oxygen atoms.

12. The metal (II) coordination polymer of claim 11, wherein coordination environment of each said 4,4′-sulfonyldibenzoic acids (H₂SBA) is μ₆-bridge ligand.

13. The metal (II) coordination polymer of claim 12, wherein said metal (II) coordination polymer is 3D network metal-organic framework (MOF).

14. The metal (II) coordination polymer of claim 1, wherein said metal (II) is Strontium (Sr).

15. The metal (II) coordination polymer of claim 14, wherein said metal (II) coordination polymer has a formula [Sr(SBA)].0.5(H₂O).

16. The metal (II) coordination polymer of claim 15, wherein each asymmetric unit of said metal (II) coordination polymer contains one Strontium (Sr) ion.

17. The metal (II) coordination polymer of claim 16, wherein each Strontium (Sr) ion in said asymmetric unit is seven-coordinated and each Strontium (Sr) ion in said asymmetric unit is coordinated with seven oxygen atoms.

18. The metal (II) coordination polymer of claim 17, wherein coordination environment of each said 4,4′-sulfonyldibenzoic acids (H₂SBA) is μ₆-bridge ligand.

19. The metal (II) coordination polymer of claim 18, wherein said metal (II) coordination polymer is 3D network metal-organic framework (MOF).

20. The metal (II) coordination polymer of claim 1, wherein said metal (II) is Manganese (Mn).

21. The metal (II) coordination polymer of claim 20, wherein said metal (II) coordination polymer has a formula [Mn(SBA)(EtOH)].

22. The metal (II) coordination polymer of claim 21, wherein each asymmetric unit of said metal (II) coordination polymer contains one Manganese (Mn) ion.

23. The metal (II) coordination polymer of claim 22, wherein each Manganese (Mn) ion in said asymmetric unit is six-coordinated and each Manganese (Mn) ion in said asymmetric unit is coordinated with six oxygen atoms.

24. The metal (II) coordination polymer of claim 23, wherein coordination environment of each said 4,4′-sulfonyldibenzoic acids (H₂SBA) is μ₄-bridge ligand.

25. The metal (II) coordination polymer of claim 24, wherein said metal (II) coordination polymer is 2D layered metal-organic framework (MOF).

26. The metal (II) coordination polymer of claim 1, wherein said metal (II) is Zinc (Zn).

27. The metal (II) coordination polymer of claim 26, wherein said metal (II) coordination polymer has a formula [Zn₃(SBA)₂(OH)₂].EtOH.

28. The metal (II) coordination polymer of claim 27, wherein each asymmetric unit of said metal (II) coordination polymer contains two Zinc (Zn) ions.

29. The metal (H) coordination polymer of claim 28, wherein one of the two Zinc (Zn) ions in said asymmetric unit is six-coordinated and is coordinated with six oxygen atoms, and the other Zinc (Zn) ion in said asymmetric unit is four-coordinated and is coordinated with four oxygen atoms.

30. The metal (II) coordination polymer of claim 29, wherein coordination environment of each said 4,4′-sulfonyldibenzoic acids (H₂SBA) is μ₄-bridge ligand.

31. The metal (II) coordination polymer of claim 30, wherein said metal (II) coordination polymer is 2D layered metal-organic framework (MOF).

32. A method for synthesizing metal (II) coordination polymers, comprising:
putting metal nitrate, 4,4′-sulfonyldibenzoic acids (H₂SBA), organic solvent, and water into a reactor in order;
heating to a predetermined temperature;
reacting at said predetermined temperature for a predetermined time;
cooling to room temperature; and
suction filtration, washing with ethanol and water, and drying to get a metal (II) coordination polymer.

33. The method of claim 32, wherein said metal (II) is a central metal of said metal (II) coordination polymer and said 4,4′-sulfonyldibenzoic acid (H₂SBA) is organic ligand of said metal (II) coordination polymer.

34. The method of claim 32, wherein said metal (II) is magnesium (Mg), Calcium (Ca), Strontium (Sr), Manganese (Mn), or Zinc (Zn).

35. The method of claim 32, wherein said metal nitrate is Mg(NO₃)₂.6H₂O, Ca(NO₃)₂.4H₂O, Sr(NO₃)₂, Mn(NO₃)₂.4H₂O, or ZnNO₃)₂.6H₂O.

36. The method of claim 32, wherein said organic solvent is ethanol.

37. The method of claim 32, wherein said metal (II) coordination polymer is synthesized by hydrothermal method.

38. The method of claim 32, wherein in said step of heating to a predetermined temperature, said metal nitrate, said 4,4′-sulfonyldibenzoic acids (H₂SBA), said organic solvent, and said water in said reactor is heated to 120° C-150° C. with 60° Ch⁻¹.

39. The method of claim 38, wherein in said step of reacting at said predetermined temperature for a predetermined time, said metal nitrate, said 4,4′-sulfonyldibenzoic acids (H₂SBA), said organic solvent, and said water in said reactor is reacted at 120° C-150° C. for about 2 days.

40. The method of claim 39, wherein in said step of cooling to room temperature, said reactor is cooled to room temperature with 6° Ch⁻¹.

41. The method of claim 32, wherein said metal (II) coordination polymer is synthesized by microwave syntheses method.

42. The method of claim 41, wherein in said step of heating to a predetermined temperature, output power is set to 400 W and then said reactor is heated to 150° C-180° C. with 60° Ch⁻¹.

43. The method of claim 42, wherein in said step of reacting at said predetermined temperature for a predetermined time, said metal nitrate, said 4,4′-sulfonyldibenzoic acids (H₂SBA), said organic solvent, and said water in said reactor is reacted at 150° C-180° C. for 20-40 minutes.

44. The method of claim 43, wherein in said step of cooling to room temperature, said reactor is cooled to room temperature with 6° Ch⁻¹.
